(19) United States
(12) Patent Application Publication
(10) Pub. No.: US 2023/0112019 A1
(43) Pub. Date: Apr. 13, 2023

(54) VIRTUAL REAL PROJECT EMPLOYEE MANAGEMENT SYSTEM

(71) Applicants: Michael Miceli, Lattingtown, NY (US); Peter Carbonara, Bayville, NY (US)

(72) Inventors: Michael Miceli, Lattingtown, NY (US); Peter Carbonara, Bayville, NY (US)

(73) Assignee: Wayne Enterprise Industries Inc., Woodhaven, NY (US)

(21) Appl. No.: 17/963,778

(22) Filed: Oct. 11, 2022

Related U.S. Application Data
(60) Provisional application No. 63/254,892, filed on Oct. 12, 2021.

(51) Int. Cl. G06Q 10/06

(52) U.S. Cl. CPC G06Q 10/06313

(57) ABSTRACT

A management system may utilize a dashboard to receive an audio or visual input recorded at a first location. The management system may wirelessly transmit the input to the dashboard from a remote recording device located at the first location. The dashboard may render one or more inputs in real time and in a format in which they are communicated via the wireless transmission connection. The dashboard may also allow for selection of portions of the inputs to create an output to be sent over the wireless transmission connection to at least one of the remote recording devices.

### RELATED APPLICATION DATA

The instant application is a non-provisional patent application claiming the benefit of priority under 35 U.S.C. § 119 from U.S. Provisional Patent Application Ser. No. 63/254,892, the entire contents of which being incorporated herein by reference in its entirety.

### FIELD OF THE INVENTION

While it is desirable to have effective onsite management and over site of construction workers/job sites and/or workers in industries where the “workplace” changes by job there are problems associated with achieving these goals that can be insurmountable. Having proper over site and management increases efficiency, productivity, quality and reduces risk and liability related to workplace injuries.

A problem many companies face is it is impossible for a qualified project manager, executive, and/or business owner to be present at multiple job sites or work sites (or even locations/floors within one job site), simultaneously to observe all of their workers at once. It is not realistic from a cost or logistic standpoint to have a management person overseeing every worker at all times on a job. It would therefore be desirable to provide a solution that would overcome these obstacles and promote better work efficiency, productivity, safety compliance and effective time management for multiple employees/workers, in multiple locations at one or more job sites or work sites.

The present invention provides for a virtual real time system for providing employee surveillance and management of employees for both safety, productivity, time/work efficiency, and compliance with safety regulations on work sites. In particular, the present invention provides for a wearable or fixed network connected device including but not limited to helmet, goggles, or safety vest (device) with one or more integrated cameras and microphones (helmet cams) that provides real time wireless streaming of audio and video data from the device to a central administrative monitor for the construction or other field worker related industry.

### SUMMARY OF THE INVENTION

In an exemplary embodiment, a virtual real time project and employee management system may provide employee surveillance, management, and oversight of employees for safety, time/work efficiency, tracking of productivity, tracking employee time and work hours for payroll function, and compliance with safety regulations. In an exemplary aspect of this exemplary embodiment, a wearable network-connected device may be used in conjunction with the virtual real time project management system, which includes, but not is not limited to, helmet, googles, safety vest, or a stationary device with integrated camera(s) and microphone(s) and/or speaker(s) that communicate real time wireless streaming of audio and video data from the wearable device to a central administrative monitor. In a preferred embodiment, the wearable devices and administrative system relate to the construction or other field worker related industry. In an exemplary aspect of this exemplary embodiment, the system may provide two-way communications between employees and the administrator in multiple locations at one or more job sites, simultaneously.

In an exemplary embodiment, data may be streamed via an audio/visual (AV) applications on both the wearable recording device and the central monitor via one or more wireless connections and allow the administrator to view multiple AV streams from multiple devices simultaneously on the administrative monitor. In one aspect of this exemplary embodiment, the AV application may have a GPS function to display on google maps or other similar website platforms and have a time tracking feature that will allow workers on a construction or other job site to clock in and out for time tracking of payroll and accounting purposes. An additional exemplary aspect may be to allow administrative overriding of automated tracking activities and instruct the application to produce time entry reports/ reporting as well as provide for job costing and other accounting and payroll related features.

In another exemplary embodiment, an IoT camera feature on the wearable device or a stationary recording device may allow for the audio/video data from a plurality of devices, in a preferred embodiment, up to 50 devices (for up to 50 workers), to be viewed simultaneously and in real time on a graphical user interface (“GUI”) or dashboard of a central administrative device (desk top, lap top, handheld device), which may allow for video analytic features such as time stamps, snap-shots in time, zoom-in features, picture-in-picture, and simultaneously play with other video feeds from other devices on a single view screen. In an exemplary embodiment, the application may allow for groupings of devices to create “views” or logical groupings based on job site or project classification as determined by the administrator. In another exemplary embodiment, an exemplary system may provide two-way (bi-directional) communications between employees and the administrator in multiple locations at one or more job sites, simultaneously.

In an exemplary embodiment, data from audio and/or video streams may be analyzed to provide real time alerts to identify potential safety hazards by determining and alerting through the management system one or more of the following circumstances: (i) Height (if an individual is working above the floor or ground level), (ii) Tracking of whether workers are wearing proper safety equipment (i.e. goggles, gloves, harnesses, work boots, hard hats/helmets, masks, and other personal protective equipment (PPE), (iii) Alerting the users if they are in proximity of fire or extreme temperatures, (iv) Identifying if they are at risk of falling (at the edge of a roof/open floor/stair case), (v) Identify if control access zones are being properly upheld, (vi) Identify if scaffolding or ladders are properly secured/tied off, and (vii) other potential risk categories regulated by government regulatory agencies including OSHA associated with the specific trade or industry the user works in. In a preferred embodiment, the management system may use Artificial intelligence to determine one or more of the above circumstances as well as track worker productivity and provide reporting to the administrator on the level of production or output produced by each individual wearing the device in a real time basis.

In an exemplary embodiment, productivity tracking may include quantifying whether a specific material is installed in a given time i.e. sheetrock, plywood, boards, rolls of a sheet membrane, paint applied, linear or square footage of a specific material installed which will be tailored and programmed on a custom basis based on the trade/task the individual wearing the device performs and/or what the administrator sets as parameters.

An exemplary management system for managing activity at a first location, may comprise a dashboard configured to receive one or more inputs recorded at the first location, wherein the one or more inputs include audio data, visual data, and combinations of the same; and a wireless transmission connection between at least one remote recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection.

An exemplary management system for managing activity at a first location, may comprise a dashboard configured to receive one or more inputs recorded at the first location, wherein the one or more inputs include audio data, visual data, and combinations of the same; and a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs, wherein the dashboard can render a plurality of inputs in real time simultaneously.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs, wherein the dashboard can render a plurality of inputs in real time simultaneously, further wherein the storage is also for the output.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs, wherein the dashboard can render a plurality of inputs in real time simultaneously, further wherein the storage is also for the output, and wherein the dashboard renders the one or more inputs in real time in conjunction with at least one non-recorded input.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs, wherein the dashboard can render a plurality of inputs in real time simultaneously, further wherein the storage is also for the output, and wherein the dashboard renders the one or more inputs in real time in conjunction with at least one non-recorded input, wherein the management system uses one of artificial intelligence or a pre-defined program to enable the output to be sent to the at least one remote recording device via the wireless transmission connection.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs, wherein the dashboard can render a plurality of inputs in real time simultaneously, further wherein the storage is also for the output, and wherein the dashboard renders the one or more inputs in real time in conjunction with at least one non-recorded input, wherein the management system uses one of artificial intelligence or a pre-defined program to enable the output to be sent to the at least one remote recording device via the wireless transmission connection, wherein the dashboard is configured to receive one or more inputs recorded over a plurality of locations other than the first location.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs, wherein the dashboard can render a plurality of inputs in real time simultaneously, further wherein the storage is also for the output, and wherein the dashboard renders the one or more inputs in real time in conjunction with at least one non-recorded input, wherein the management system uses one of artificial intelligence or a pre-defined program to enable the output to be sent to the at least one remote recording device via the wireless transmission connection., wherein the dashboard is configured to receive one or more inputs recorded over a plurality of locations other than the first location, wherein the plurality of inputs come from a plurality of wearable recording devices.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs, wherein the dashboard can render a plurality of inputs in real time simultaneously, further wherein the storage is also for the output, and wherein the dashboard renders the one or more inputs in real time in conjunction with at least one non-recorded input, wherein the management system uses one of artificial intelligence or a pre-defined program to enable the output to be sent to the at least one remote recording device via the wireless transmission connection, wherein the dashboard is configured to receive one or more inputs recorded over a plurality of locations other than the first location, wherein the plurality of inputs come from a plurality of wearable recording devices.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs recorded over a plurality of locations and the first location, wherein the dashboard can render a plurality of inputs in real time simultaneously, further wherein the storage is also for the output, and wherein the dashboard renders the one or more inputs in real time in conjunction with at least one non-recorded input, wherein the management system uses one of artificial intelligence or a pre-defined program to enable the output to be sent to the at least one remote recording device via the wireless transmission connection, wherein the dashboard is configured to receive one or more inputs recorded over a plurality of locations other than the first location, wherein the plurality of inputs come from a plurality of wearable recording devices.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs recorded over a plurality of locations and the first location, wherein the dashboard can render a plurality of inputs in real time simultaneously, further wherein the storage is also for the output, and wherein the dashboard renders the one or more inputs in real time in conjunction with at least one non-recorded input, wherein the management system uses one of artificial intelligence or a pre-defined program to enable the output to be sent to the at least one remote recording device via the wireless transmission connection, wherein the dashboard is configured to receive one or more inputs recorded over a plurality of locations other than the first location, wherein the plurality of inputs come from a plurality of wearable recording devices and the dashboard is configured to instruct the management system on which of the plurality of wearable devices to send the output via the wireless transmission connection.

An exemplary management system for managing activity at a first location, may comprise a dashboard configured to receive one or more inputs recorded at the first location, wherein the one or more inputs include audio data, visual data, and combinations of the same; a wireless transmission connection between at least one wearable recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection; and a storage for the one or more inputs recorded over a plurality of locations and the first location, wherein the dashboard can render a plurality of inputs in real time simultaneously, further wherein the storage is also for the output, and wherein the dashboard renders the one or more inputs in real time in conjunction with at least one non-recorded input, wherein the management system uses one of artificial intelligence or a pre-defined program to enable the output to be sent to the at least one remote recording device via the wireless transmission connection, wherein the dashboard is configured to receive one or more inputs recorded over a plurality of locations other than the first location, wherein the plurality of inputs come from a plurality of wearable recording devices and the dashboard is configured to instruct the management system on which of the plurality of wearable devices to send the output via the wireless transmission connection and in what format to send the output via the wireless transmission connection.

A management system for managing activities at a remote location may have a controller by which the management system receives remote inputs and delivers outputs to the remote location; a wearable recording device configured to transmit and receive data to the controller via a wireless transmission, wherein the data includes, audio data, visual data, text data, and combinations of the same; a storage unit digitally coupled to the controller and the wearable recording device, wherein at least a wireless transmission connection between at least one remote recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection.

A management system for managing activities at a remote location may have a controller by which the management system receives remote inputs and delivers outputs to the remote location; a wearable recording device configured to transmit and receive data to the controller via a wireless transmission, wherein the data includes, audio data, visual data, text data, and combinations of the same; a storage unit digitally coupled to the controller and the wearable recording device, wherein at least a wireless transmission connection between at least one remote recording device located at the first location and the dashboard, wherein the first location and the dashboard are remote from one another, wherein the dashboard renders the one or more inputs in real time and in a format in which they are communicated via the wireless transmission connection, and at least a portion of the one or more inputs may be selected via the dashboard to create an output in the management system, wherein the management system enables the output to be sent to at least one remote recording device via the wireless transmission connection, wherein the dashboard renders the one or more inputs from a plurality of remote recording devices simultaneously.

### BRIEF DESCRIPTION OF THE DRAWINGS

FIG. 1 illustrates an exemplary utilization of an inventive system in a work scenario.

FIGS. 2 and 2A illustrate views of an exemplary embodiment of an IoT device for use in the inventive system disclosed herein.

FIG. 3 illustrates an exemplary dashboard embodiment for use in the system disclosed herein.

FIG. 4 illustrates an exemplary diagrammatic layout of an exemplary inventive system.

FIG. 5 illustrates an exemplary flow program of operation of one embodiment of the inventive system.

FIG. 6 illustrates another exemplary flow program of operation of one embodiment of the inventive system.

FIG. 7 illustrates an exemplary flow program of operation of a further embodiment of the inventive system.

FIGS. 8A-E each illustrates an exemplary dashboard embodiment of the inventive system.

FIG. 9 illustrates another exemplary diagrammatic layout of an exemplary inventive system.

In the drawings like characters of reference indicate corresponding parts in the different figures. The drawing figures, elements and other depictions should be understood as being interchangeable and may be combined in any like manner in accordance with the disclosures and objectives recited herein.

### DETAILED DESCRIPTION

The present invention provides a method and a system for real time supervision and project management including time management, and analytics via Artificial Intelligence (“AI”) of multiple employees at multiple job sites including but not limited to construction sites.

An exemplary user, worker, employee, end-user, helmet wearer, may be considered the same as a camera view. In an exemplary embodiment, an exemplary user may be one or more person, preferably up to 50 persons, and/or at least one device, e.g., a stationary camera, on site overlooking the location or locations.

An exemplary admin or administrator may be a human or computerized algorithm having access to a web-application software for monitoring and reviewing recordings or AV streams from one or more exemplary camera views. In a preferred embodiment, an exemplary admin may be a human with roles such as an owner, supervisor, leader, manager, administrator, and/or foreman.

An exemplary dashboard may be the web-application that a human admin may use to review and monitor stream data from exemplary Internet-of-Things (“IoT”) devices, such as, for example, Amazon Web Services (AWS), which is a particular type of IoT optimized for accepting IoT device data and storing it. The AWS IoT One-click is a service provided by Amazon Web Services (AWS) that is optimized for accepting TOT device data and storing it. Services such as these simplify development and cost. An exemplary dashboard may also be a conventional web application that is connected to the device via the Internet for “real time” data communications. The dashboard may also access data stored in either the cloud storage and/or a central storage network, e.g., Network Video Recorder (NVR), which will enable playback of camera footage. An exemplary NVR may be a device that records audio and visual data streamed form IoT cameras via Wi-Fi or Cat 5 Ethernet, and may have an internal hard drive. An exemplary NVR may also have an interface to review the video recordings and set up various connections to stream the data to the Internet. An exemplary “real time” data communication may be the type provided by exemplary web-based services such as, for example, Zoom®, Microsoft Teams®, and Google Meet®.

References to “Internet” would be understood by persons of ordinary skill in the art to be the world-wide-web, which may be required to access and view camera recordings remotely in real time. Additionally, “Internet” may also include other interconnections between devices such as via wireless and wired networks, including Bluetooth®, Wi-Fi, and other cellular-based connections. In an exemplary embodiment, the absence of an Internet connection may limit the system to local review of camera recordings.

An exemplary cloud storage may be a service provided by cloud service providers such as AWS that allow for direct storage online without the need to store locally, such services being alternatively referred to as S3 and/or RDS.

An exemplary IoT camera may be any device with visual/audio recordation capabilities and have ability to connect to the Internet. Exemplary IoT cameras may typically function as stand-alone devices only requiring configuration and power. In an exemplary embodiment, an exemplary IoT camera may connect directly to a central administrator, cloud server, and/or NVR in order to transmit the video/audio collected directly via a streaming connection. In another exemplary embodiment, an exemplary IoT helmet-cam may be a device that can record in color video and high-definition audio and be configured to transmit data collected to the central administrator monitor and/or device, cloud-based storage, and/or the NVR via a wireless, e.g., Wi-Fi 33. connection and/or router to an Edge server, such as, for example, the Cloudflare CDN server.

In an exemplary embodiment, the AWS one-click setup may transmit a recorded stream to a Lambda function, such as one provided for by the AWS Lambda compute service, at which point computational logic may process the stream and save it into the appropriate data storage format and location. Additionally, and alternatively, the AWS Lambda compute service may also process the stream and trigger various other functions, such as, for example update or provide notifications and update a log of events.

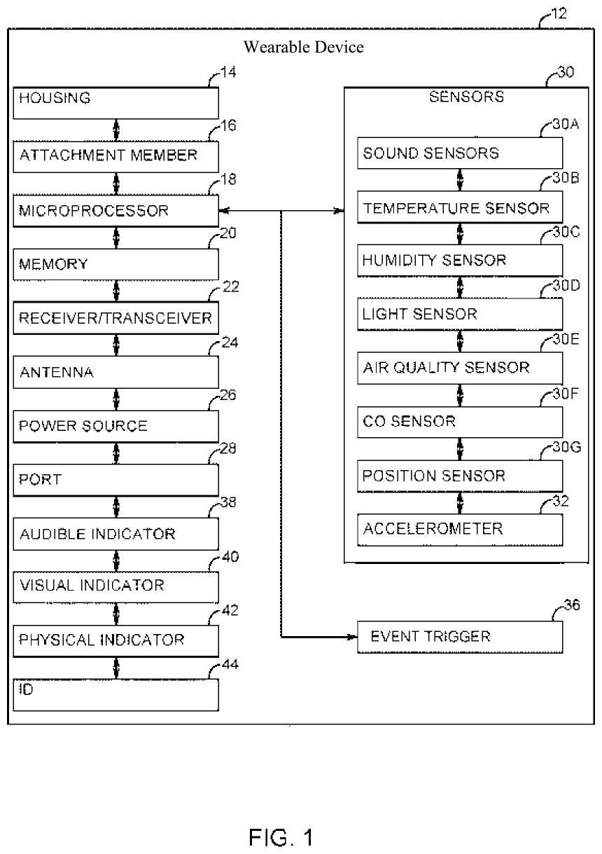

With reference to FIG. 1, an exemplary use case involving the system may be represented. An administrator 4 may use an exemplary admin management system 100 such as a computer, a network of computers, a smart phone, laptop, or other equipment with digital renditions of video with configurations to provide audio to a user. An exemplary admin management system 100 may be configured to display an exemplary dashboard 50 on which an administrator 4 may be able to see and/or hear events and objects taking place at a remote location. In an exemplary embodiment, the remote location is a construction work site or other work site for mining, trucking, manufacturing, hospitality, entertainment, and/or service industries. Alternatively, a remote location may be a hospital, a school, a campground, a beach, a commercial establishment, an outdoor establishment, and/or a combination of the same. Dashboard 50 may comprise an LCD or OLED screen through which an array of video streams and/or audio streams may be provided for viewing, manipulation, and editing by the administrator 4. In an exemplary embodiment, the dashboard 50 may show streams 5A, 6A, 7A, 9A, and 10A representing video being transmitted in real time remotely from users 5, 6, 7, 9, and source 10. In a preferred embodiment, the system 100 may provide streams from as many as 50 different users and/or devices, across numerous locations/job sites and communicate the streams in a way to maximize efficiency, productivity, safety protocols, compliance with regulations, etc., simultaneously.

According to the illustrative embodiment of FIG. 1, an exemplary user 5 may be located in a position 1A while streaming video and/or audio using a wearable recording device, such as, for example, a helmet with an TOT camera or other network connected device including but not limited to a vest, goggles, belt, or other accessory that is configured to provide a bi-directional communication link 5B between the video recorded and the dashboard 50 of the management system 100 operated by administrator 4. Devices capable of such streaming are known to those skilled in the art and are contemplated for use in accordance with this and other embodiments disclosed herein. Exemplary user 5 may use his/her helmet to record video and/or audio within range 5A, which may include position 1C as well as the portions of users 6 and 8 that are visible beyond position 1C. As such, the dashboard 50 on system 100 may provide the recorded media (video and/or audio) in the part of the dashboard denoted “5A” based on data remotely communicated to it via bi-directional link 5B. An exemplary bi-directional link 5B may comprise one or more of the wireless data transmission protocols and methods disclosed herein.

With further reference to FIG. 1, exemplary user 6 may also use his/her TOT helmet to transmit media within range 6A back to dashboard 50 via link 6B. However, the media within range 6A may be different from that of range 5A in that range 6A has side 2A of position 2 and the majority of user 5 that is not obstructed by position 1C. According to this exemplary embodiment, both users 5 and 6 may provide the admin 4 with a more comprehensive view of the users and the positions found among 1A, 1C, and 2. The addition of media recorded via user 9's IOT device within range 9A may add to the complete view of the positions at 1A, 1C and 2 by obtaining additional views of users 6 and 8 that may not be obstructed by position 1C (as may have been the case for user 5) and further adds to the streamed content collected by user 5 by providing an additional vantage point for viewing users 6, 8, and position 1C. The data link 9B would provide this additional data to the dashboard 50, which may be configured to place the stream adjacent streams detected by internal algorithms to be of the same adjacent locations (e.g., stream 9A would be placed adjacent streams 5A and 6A based on their being taken at or near locations 1A, 1C, and 2). The system 100 may be pre-configured to know that locations 1A, 1C, and 2 are adjacent one another to automatically organize streams recorded at those positions in the dashboard or use of machine learning and/or known artificial intelligence models to iteratively determine that the streams are in adjacent locations and be grouped adjacent one another accordingly for viewing by admin 4 on dashboard 50.

In an exemplary embodiment, the exemplary arrangement of FIG. 1 may allow the admin 4 to determine whether users 5 and 6 have all the requisite gear on them to accomplish a particular task or satisfy one or more regulatory provisions, e.g., safety compliance, OSHA, or other rules applicable to the location/activity. Additionally, or alternatively, an exemplary admin 4 may be able to determine that user 8 does not have their own IoT device enabled or in his/her possession and notify user 6 to inform user 8 of that fact and take corrective action. Alternatively, user 8 may be using a different type of IoT device (e.g., a vest), which is not recording anything at present, which may be confirmed by a lack of streaming data communicated by data link 8B back to dashboard 50. Additionally, the combination of streams 5A and 9A from users 5 and 9, respectively, may allow admin 4 to alert one or more of users 5, 6, and/or 9 that user 8 may be approaching an edge of position 1C that may be a potential hazard. Alternatively, if user 8 is wearing an audio-only device on his/her person, then admin 4 may alert user 8 directly that he/she may be encountering a danger at their location along position 1C. Further alternatively, user 8 may require assistance in a task at their location at position 1C that may be best suited for handling by user 9. An exemplary admin 4 may be able to direct user 9 to change his/her location adjacent 1A to be at a position 1C in order to assist user 8 in a particular task. Thus, admin 4 may utilize these various exemplary aspects of the disclosed system to manage the users 5, 6, 8, and 9 in a way that would not be possible unless otherwise physically present at the aforementioned locations.

With further reference to FIG. 1, an exemplary user 7 may be found in position 1B presenting a data stream over range 7A using his/her IoT device, e.g., IoT helmet, that captures a portion of position 2B and user 11 located thereon. The captured audio/video stream from user 7 may be communicated to dashboard 50 via link 7B. Additionally, an exemplary station 10 may be located on position 3 and also configured to provide recorded data streams over range 10A. In an exemplary embodiment, admin 4 may start by viewing the data from link 10B associated with the stream 10A from station 10 that was affixed at position 3 prior to any streaming by users 6-9. In other words, in an exemplary embodiment, station 10 may be the first provider of streaming video and/or audio to dashboard 50. Admin 4 may see user 7 looking up in the stream 10A and audibly direct user 7 to turn on his/her IoT device using either station 10 or other communication means on the person of user 7. In this way, admin 4 may be able to direct dynamic streaming by users via static streams from devices, such as station 10 in FIG. 1. As in the combination of streams 5A and 6A, the combination of streams 10A and 7A may also provide a more comprehensive understanding of positions 1B, 2B, and 3 for admin 4. In like manner as streams 5A, 6A, and/or 9A, system 100 may be configured to place the data streamed via links 10B and 7B adjacent one another on the dashboard 50 for more comprehensive handling by admin 4.

In an exemplary embodiment, an exemplary user 11 may have an IoT device but only enable the audio due to difficulties in acquiring video using his/her wearable device (e.g., broken component, obstructions of the video lens, lighting conditions, smoke, rain). Under such situations, user 11 may receive audio only input 11C that would be transmitted back via link 11B to dashboard 50 to be played separately, optionally at the selection of admin 4, or in conjunction with the streams 7A and/or 10A. In other words, according to another exemplary embodiment, system 100 may be capable of overlapping media from different streams with one another to enable the admin 4 to obtain a more comprehensive understanding of the positions. For example, an exemplary system 100 may be able to play user 11's audio input 11C during the stream 7A. Alternatively, if system 100 deduces that user 11 may be trying to reach user 8, but user 8 does not have a means of communicating with user 11, then system 100 may be able to transmit user 11's audio input 11C to user 6 and user 9 to allow them to communicate the same to user 8. According to this alternative aspect of the innovative system herein described streams and/or inputs received by the system from any user or group of users may be communicated to any other users via the links to system 100 either automatically based on algorithms in the system and/or by admin 4. Another example of this alternative aspect may involve user 6 sending video 7A to user 5 to alert user 5 not to do work on position 2A because user 11 is located on the opposite side 2B. Again, the advantageous integration of communication links amongst all users via system 100, whether automatically or via admin 4, may increase the safety and productivity at a particular location comprised of numerous positions.

In still further embodiment, audio input 11C may be audible sounds from users 5, 6, 8, and/or 9. Therefore, user 11's audio input 11C from users 5, 6, 8, and/or 9 may allow admin 4 to determine from the corresponding data links 11B, 5B, 6B, 8B, and/or 9B that positions 1A, 1C, and 2A are adjacent, close to, or distant from positions 1B 2B, and 3. Accordingly, admin 4 may be able to determine relative proximities between users at different locations using inputs received by each of them at a particular site, e.g., a work site. This particular embodiment may be especially useful in new construction work where relative locations of particular parts of a building or establishment are not yet known or still being developed. System 100 may be configured to deduce from the various inputs received, e.g., audio and video, from the various data streams the approximate layout of the space comprising positions 1A, 1B, 1C, 2, and 3 using A.I., machine learning, or other iterative methodologies. Additionally, an exemplary system 100 may be able to detail for an admin 4 a particular overall depiction of the aforementioned positions based on the combination of audio and video inputs from the various dynamic user inputs and/or static device(s).

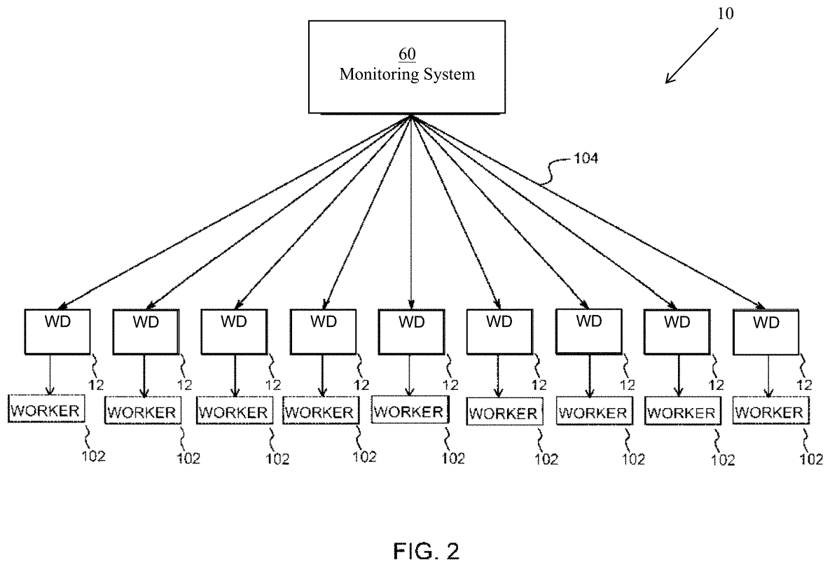

An exemplary IoT device 20 may be shown in FIGS. 2 and 2A. According to this exemplary embodiment, device 20 may be in the form of a helmet configured with video acquisition means 25, such as an audio/video IoT camera known to those skilled in the art. The means 25 may be disposed anywhere on the device 20 depending on needs of the application. In an exemplary embodiment, device 20 may be used at construction sites for which the most optimal placement of means 25 is on the outer surface 21 of device 20 above the rim 23 facing the same direction as the eyes of the user (not shown). Opposite the means 25 may be an input/output port 26 configured for charging, transmission of data via wireless or wired connections (e.g., a USB or Bluetooth enabled antenna port), and/or an AC adaptor for charging the electronics of device 20. Gear attachment 24 may be located about device 20 where necessary to allow for attachment of various wearing conveniences, such as harness straps for the face of a user, personal protective equipment such as face shields, masks for hazards, eye wear, audio inputs that work separately or in conjunction with the electronics of device 20, such as, sensors and other components in electronic housing 27. Again, while electronic housing 27 may be shown in a particular location about device 20, it may be oriented elsewhere as needs require.

Referring to FIG. 2A, which is the cross-section reflected by the dashed line A-A in FIG. 2, an exemplary device 20, again resembling a helmet, may show the aforementioned means and other devices along with exemplary internal wearability means, such as strap 30, and an exemplary internal connection network 31/32 to electrically couple one or more components 25, 26, 27A-C, and 28 to one another using some or all of the thickness of device 20 and/or wearability features, such as head strap 30. Those skilled in the art would understand the use of manufacturing techniques to line fabric with electrical wires to form the interconnections illustratively shown in FIG. 2A and/or embed such connections in the material making up device 20. Alternatively, the electrical network may be pre-constructed and mounted within device 20 using adhesives and other mechanical attachments, such as, for example, hooks, snap-buttons, snap-fit, or other mechanical interlocking means to allow for adjustment, replacement, powering, and using of the same in a device 20 under normal working conditions.

Electrical features 27A, 27B, and 27C may represent one or more types of sensors that may be accommodated by an exemplary device 20. For example, features 27A-C may individually or collectively provide for the following types of data/sensory inputs to be communicated via an appropriate data link (e.g., link 5B of FIG. 1) to system 100 and/or be communicated to user of device 20 (e.g., via audio or visual means): location (latitude & longitude), such as, for example, GPS, altitude, decibel levels, outside temperature, time & date, steps taken, barometric pressure, button inputs, head perspiration levels, head temperature, vibration levels, gyroscopic level, body form analysis, voice activation and voice commands, and analysis of body movement.

Electrical feature 28 may be a battery pack or other power source to allow for longer use of the electronics of device 20. Alternatively, feature 28 may be a data repository for the data collected via the electronics on device 20 that may be capable of coupling to a workstation via one or more of wireless or wired connections known to those skilled in the art. Further, feature 28 may also comprise sensors of the type described herein and/or additional video/audio inputs. In embodiments where Feature 28 may be another video/audio acquisition means, the system 100 may benefit from multiple data streams from a single user and thereby increase the comprehensive view, understanding, and management of the location by the system 100 and/or admin 4. It would be understood that in accordance with these and other embodiments, the skilled artisan would understand that with appropriate placement of data acquisition features on a device 20, the system 100 may exponentially increase the usefulness of the remote viewing and remote handling of the participants in the network by admin 4 and/or system 100.

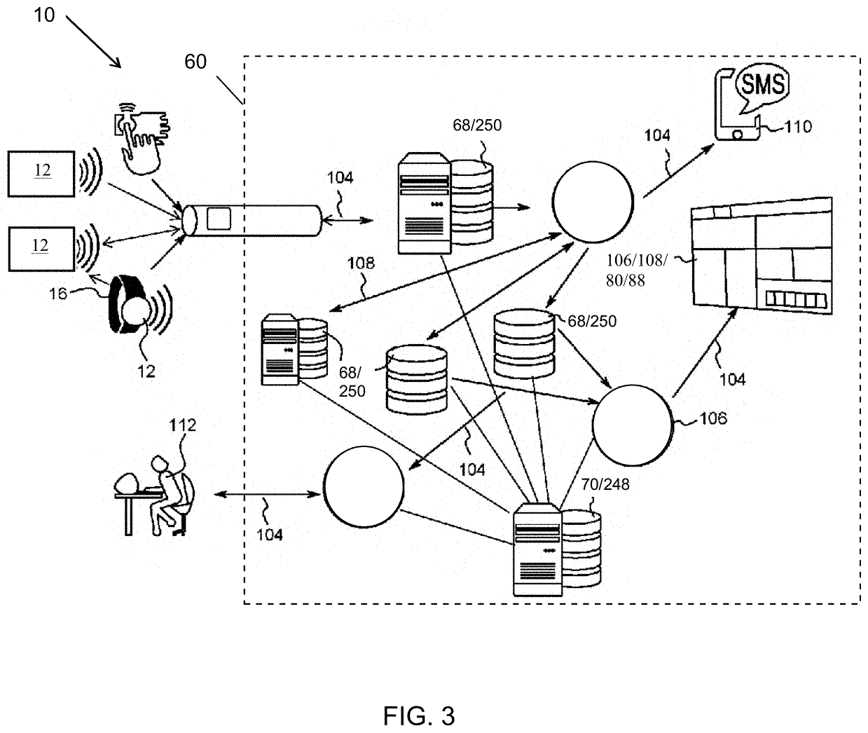

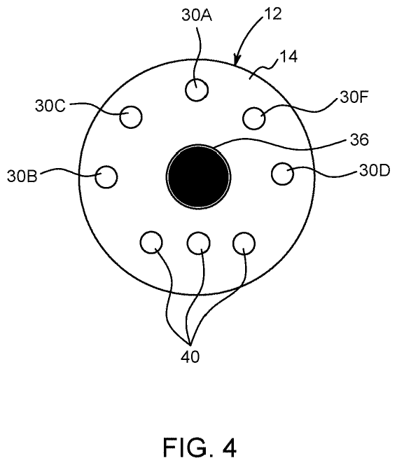

With reference to the illustrative embodiment of FIG. 3, the system 100 may comprise a further variation of the dashboard 50 comprised of a number of dynamic graphical user interface (“GUI”) features in addition to any of the real-time view screens depicted in the dashboard 50 of FIG. 1. According to FIG. 3, the real time video stream 5A/6A/7A/9A/10A that would otherwise be capable of occupying a larger portion of the dashboard 50 (as shown in FIG. 1) may be formatted to be smaller in size so that the admin 4 may further use that video stream in conjunction with other features of the system 100. For example, the system 100 may instantaneously collect and/or receive details of the entire location and/or iteratively build the location from gathered data through AI and display a map 52 on the dashboard 50. Using a cursor 53, the admin 4 may select the user displayed on the map 52 to create a window 51 in which the admin can view the real time video of the selected user (in this case and in accordance with the user/stream convention of FIG. 1, stream 9A would be displayed in window 51 based on the cursor 53 being placed on the graphical depiction of user 9 on map 52). However, the system 100 may also then display in window 51 numerous other features based on data stored by the system 100 either via cloud storage or via local storage, e.g., an NVR hard drive, as well as features that are derived from Lambda functions available via the AWS service or like service module. Additionally, the system 100 may output its data for receipt in different file formats such as document files, spreadsheets, and management software files such as, for example, Microsoft Project® and Microsoft Access®. Further, the live streams received via the dashboard 50 may be incorporated into Zoom or Microsoft Teams calls between the admin 4 and third parties.

According to an exemplary embodiment, the selection of user 9 in map 52 by cursor 53 may autogenerate statistics and information related to user 9 that is stored by the system, such as, for example, a worker identification information, the worker's job responsibilities, licensure, working statistics, payroll, attendance, violations, equipment authorized to be used, and other information relevant to the user's relationship to the task under review by admin 4. Additionally, in an exemplary embodiment, the selection of user 9 in map 52 by cursor 53 may allow the admin 4 to make audio calls from the dashboard 50 to the user using an audio button located on the dashboard 50 (e.g., in window 51 in the illustrative embodiment of FIG. 3, but it may be elsewhere). According to an aspect of this exemplary embodiment, the audio call between admin 4 and user 9 via dashboard 50 may be recorded and also stored by the system 100 for later use and/or to show quality control and other compliance actions. Additionally, the dashboard 50 may also permit use of safety issue selections and other alerts (e.g., using buttons pre-populated based on prior activities or autogenerated based on AI or input from admin 4). These alerts may come in the form of audio to the user being selected (e.g., user 9), or may be alerts sent to the most adjacent user to user 9 based on lambda functions that calculate the next closest user to assist. For example, if user 9 is tasked with lifting an object and requires immediate assistance, an admin 4 can issue a help alert via the dashboard 50 and in particular a “help user 9 alert” in window 51 that the system 100 would automatically route to user 5 who is the closest user to user 9 to assist. In the event user 5 may not be able to assist within a predetermined time period, the system 100 may then send the same “help user 9 alert” to user 6. Accordingly, system 100 enables the admin 4 to accomplish tasks that would require multiple individual calls from admin 4 just by clicking one button on the dashboard 50 and the use of appropriate lambda functions.

In yet another exemplary embodiment, admin 4 may use the real time video feed to save by time stamp certain completion of work tasks that would be automatically stored and updated in any milestone event or project tracking implemented by the system 100. For example, admin 4 may identify a milestone at a particular segment of the video stream received in the dashboard 50 by clicking a “milestone” or like button. At that point in time, the video segment may be saved on the system 100 storage as evidence of the milestone and any appropriate tasks to which it pertains may be updated. In an exemplary embodiment, system 100 may output a document or other file that may be used by a third party with hyperlinks embedded in the document that link to the stored video streams showing satisfaction of the work and in which the timestamp can be visible. In this way system 100 may be used by an admin 4 to create dynamic reports with embedded files that prove satisfaction of statements of work, progress reports which provide video evidence of the progress, and audible/visual confirmation that a task has been completed. The generation, including automatic generation, of such dynamic documented reports is another exemplary feature of a system 100 according to the disclosures herein.

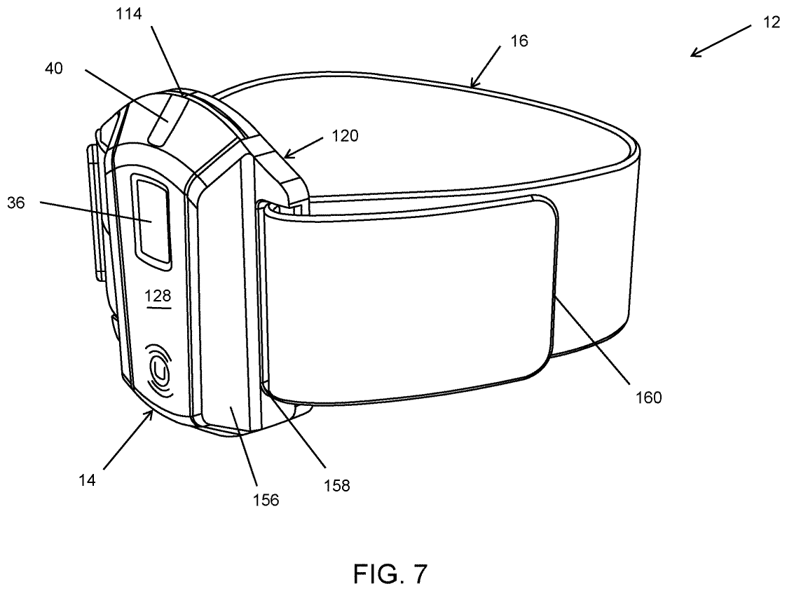

In another exemplary embodiment, admin 4 may also access archived video via the dashboard 50 that is stored by the system 100 in the cloud or on a local hard drive. The system 100 may provide several different ways to index the archived video, such as by the methodologies disclosed with respect to FIGS. 6 and 7. Additionally, the manager 4 may index archived video manually based on content, time, activity type, etc.

In another exemplary embodiment, an admin 4 may make changes to statements of work (“SOW”) via the dashboard 50 that may subsequently cause simultaneous updates of instructions to all users working under the particular SOW. In this way, the admin 4 need not communicate the SOW changes to every user individually, but can use the system 100 to accomplish that task. Furthermore, admin 4 may also be able to manage the users graphically using map 52 by moving the GUI of the users to different positions, which the system 100 would then indicate via an alert to the user to make the suggested change. For example, if admin 4 would like user 8 to move from their location at position 1C to position 1B, admin 4 may move cursor 53 to the GUI marked “8” and drag it to position 1B on the map 52. Upon making that change on the dashboard 50, user 8 would be directed by the system 100 to go to the new location at position 1B, either via GPS commands or by being connected to the audio of another user in that same position, in this case, the audio of users 7 and/or 11. Again, the admin 4 may graphically control the work site using the dashboard 50 and the interactivity of the user's IoT devices 20 and the corresponding link to the dashboard 50.

In yet another exemplary embodiment, admin 4 may switch between different groups of users in different locations by using a sorting feature window 54. Accordingly, admin 4 may isolate workers that have particular competences (e.g., licensed plumbers, nurses, firemen, carpenters, CPR certified persons), leadership roles (e.g., foreman, school principals), quantity of remaining work or work in progress (e.g., persons who have completed their tasks who can leave the site, persons who need additional assistance to complete work), or other customized sorts based on needs. The system 100 may call upon any stored data as well as any AI-learned features of the users in the field to enable admin 4 to isolate particular users to focus their management. While dashboard 50 may show map 52, an exemplary system 100 may have a plurality of such maps that can show different work sites with activities taking place therein. In an exemplary embodiment, the admin 4 may have multiple job sites available for view in map form and/or video stream forms, which can be minimized and maximized depending on the admin 4 and/or the system 100's presentation of potential alerts and/or safety issues.

In a further exemplary embodiment, the working statistics of a particular user may be the time at which he/she started, the time spent working at a particular task or in a particular position, the equipment utilized by the user, and the amount of movement the user has made throughout a period of time. Thus, an exemplary system 100 may allow the admin 4 to assess whether a user is working efficiently, effectively, safely, and correctly at any point in time and in real time. The system 100 ability to provide working statistics at the admin 4 selection on dashboard 50 also provides the admin 4 with access to relevant information that can be used in managing the project involving the particular user selected. For example, admin 4 may move users on map 52 as discussed elsewhere herein to enable better utilization of their availabilities and skill sets.

In an exemplary embodiment illustratively provided for by FIG. 4, a user 5 adorning an IOT camera(s) on his/her device 20 may transmit data 5A through a link 5B to the dashboard 50 of system 100. An exemplary link 5B may comprise one or more of the following in any combination of transactional relationships: an AI EDGE server 30, local storage(s) 35, the Internet 40, an AWS IoT 45 (such as an AWS IoT one-click service), and one or more cloud storage(s) 46. In an exemplary embodiment, the AWS IoT 45 may be used to perform computations with lambda functions to execute a desired action. For an exemplary computation, the AWS one-click 45 may transmit the data or stream 5A to a Lambda function 45A, at which point, the system 100 may use computational logic to process the stream 5A and save it into the appropriate data storage services such as cloud storage 46 or an appropriate local storage 35, such as, for example, NVR. Additionally, the lambda function 45A may also be used to trigger various other functions in the dashboard 50 related to the application requirements, such as notifications and logs. In a further exemplary embodiment, cloud storage device 46 may play back the data/feed 5A and transmit the data 5A through the internet 40 to dashboard 50, which may be a web-based application an administrator 4 may use to review and monitor the data 5A.

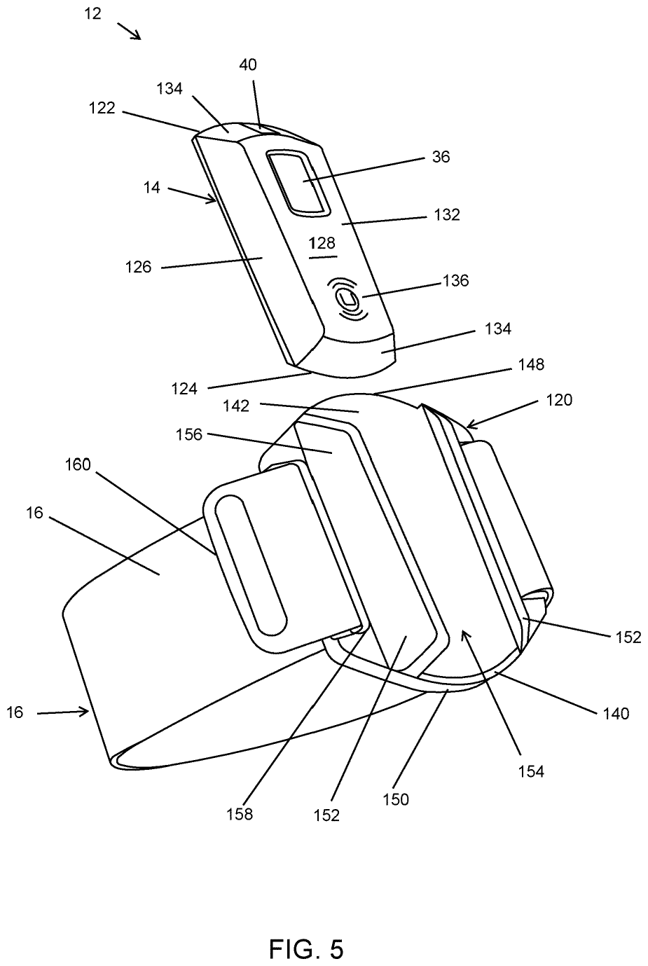

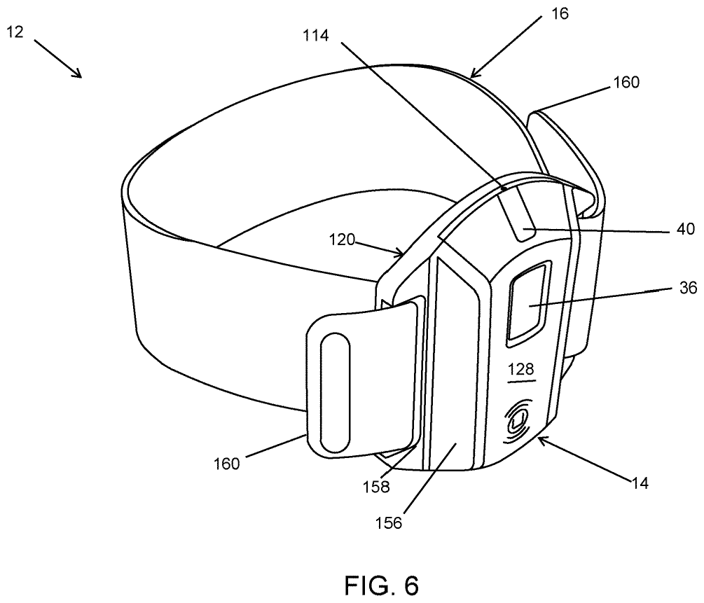

According to an exemplary system 100 operation as illustrated by FIG. 5, an exemplary system 100 may receive via step 501 one or more real-time audio/video streams at discrete time intervals (T₀, Tₙ, Tₙ₊₁) which it converts from the analog format at the point of reception (e.g., device 20 and/or station 10) into a digital output at step 502. At that point the system may do one or more of the following steps: archive the digitally converted stream at step 503, determine whether there has been a request for real-time viewing at step 504, determine whether there is a request for archival review at step 505, and in the event of either steps 504 or 505, whether the request is for multiple real-time streams (step 506) and/or multiple archive reviews (step 507), respectively. Once the output selection is made at step 508, the system 100 may be configured to display the requested output at step 509 and/or download the requested output at step 510. While the process illustrated by FIG. 5 may provide for sequential output selections of real-time streams and archived streams, the system 100 may enable parallel output selection depending on needs. For example, an admin 4 may simultaneously request prior recorded video of a particular work task to play simultaneously during the real time stream requested in order to provide instruction to the present user(s) providing the real-time streams based on the archived stream. Accordingly, the system 100 may enable the admin to send prior streams of work to new users to assist in updating new personnel (e.g., provide training videos, project attack strategies, compliance training) or allowing one user to continue prior work in the same manner previously undertaken. This aspect of the exemplary system 100 enables more efficient handling of matters at a worksite while relieving the admin 4 of having to re-instruct personnel over and again.

In an exemplary aspect, the system 100 may provide the following benefits: work safety, efficiency, monitor multiple locations simultaneously, time management/location system, two-way communications to communicate with employees regarding work to be done, monitoring how much work being done, labor law compliance, Safety and Occupational Hazard (OSHA) Compliance, among others.

The AI aspect of the system 100 and presentation of worker statistics enables increased productivity by allowing real time and historical analysis of user behavior that impact job completion, safety, and compliance to reduce violations, accident occurrence, and stake holder satisfaction.

In another exemplar aspect, the system 100 may also provide accountability throughout all points of a work task, including ways by which an admin 4 may trace any installation or effort to a source, review the implementation and track/audit performance. Furthermore, the system 100 provides the admin 4 with ways to measure task performance in terms of time, money, and overall impact on the particular work task.

The present invention provides for use of artificial intelligence in data assessment and collection. To begin with, machine learning is a branch of computer science in the field of Artificial Intelligence that is based on a machine learning algorithm that “learns” and improves efficacy using a training dataset, either trained with guidance or trained by deep learning. With guidance, a model can be designed to identify any particular thing. For example, you can train a machine to recognize a yellow hammer, every video and frame that contains a yellow hammer will be flagged and reinforced, the machine will then be able to identify yellow hammers in any video. Some non-limiting examples of machine learning algorithms include regression algorithms (such as, for example, Ordinary Least Squares Regression, Linear Regression, Ridge Regression, Neural Network Regression, Lasso Regression, Decision Tree Regression, Random Forest, KNN Model, and Support Vector Machines (SVM)), instance-based algorithms (such as, for example, Learning Vector Quantization, k-nearest neighbors algorithm, kernel machines and RBF networks), decision tree algorithms (such as, for example, classification and regression trees), Bayesian algorithms (such as, for example, Naive Bayes and semi-Naïve Bayes, such as averaged one-dependence estimators (AODE)), clustering algorithms (such as, for example, k-means clustering), association rule learning algorithms (such as, for example, Apriori algorithms), artificial neural network algorithms (such as, for example, Perceptron and the backpropagation algorithm), deep learning algorithms (such as, for example, Deep Boltzmann Machine), dimensionality reduction algorithms (such as, for example, Principal Component Analysis), ensemble algorithms (such as, for example, Stacked Generalization), and/or other machine learning algorithms known to those skilled in the art.

Examples of machine learning technology and other artificial intelligence that may be utilized in the present system may include the technologies disclosed in one or more of U.S. Pat. Nos. 8,044,996, 8,126,279, 8,577,085, 9,070,216, 9,080,216, 9,208,612, 9,852,238, and 9,996,229, the disclosures of each of which being incorporated herein by reference in their entirety.

Artificial intelligence may be leveraged to audit, review, and analyze the video and audio recordings to extract key metadata (about the video/audio recorded), such as the number of hours of footage, which employees or contractors are present and when, to perform complex analysis tasks, and provide recommendations.

One application of a Machine Learning implementation is to automatically identify high and low performers on the job, or those that are violating work policies, or safety regulations, based on the record video and audio and video data, without the need of human intervention analysis.

Another application of a Machine Learning implementation is to identify flaws in the way something was assembled, installed, or configured. Still another application of a Machine Learning implementation is to help locate lost tools on the job site, an end-user can click the find my tool button in the app, and the app might scan for all their tools recorded and provide the area the tool was last seen at. Yet another application of a Machine Learning implementation is to notify end-users of overworked or burned-out employees, or those producing less than what would be expected or regulated.

Another application of a Machine Learning implementation is to recognize or identify toxic employees that are harming the general work environment and productivity of 405 nearby workers. Further another application of a Machine Learning implementation is to catalog which tools users like to use, and how long these tools last per discipline, for example, carpenters might utilize a hammer, while roofers might utilize on average a nail-gun more often. This information can be distributed or sold to tool manufacturers.

Moreover another application of a Machine Learning implementation is to catalog all safety regulation violations, actual workplace accidents, how they occurred, and potentially how they can be prevented. Alerts will be sent to the user of the device, including, but not limited to, administrator 4 as well as other personnel to which access is given by or through admin 4, if the machine learning identifies a potential hazard so that the user is aware and the hazard can be avoided Also another application of a Machine Learning implementation is to recognize aggressive behavior, fights, or arguments, in the workplace.

Still another application of a Machine Learning implementation is to recognize or identify toxic employees that are harming the general work environment and productivity of nearby workers. A further application of a Machine Learning implementation is to catalog which tools users like to use, and how long these tools last per discipline, for example, carpenters might utilize a hammer, while roofers might utilize on average a nail-gun more often. This information can be distributed or sold to tool manufacturers.

In addition, another application of a Machine Learning implementation is to catalog all safety regulation violations, actual workplace accidents, how they occurred, and potentially how they can be prevented. This information can be used for safety videos and sold to statistical analysis services.

In addition to the above, the AI (artificial intelligence) features of the present invention may also enable the system to do one or more of the following, concurrently, sequentially, or in any other order or format: (i) Identify is someone is above (or below) ground a certain height (e.g., worker at the top of a 10 foot scaffold); (ii) Identify if someone is close to a ledge; (iii) Identify if safety railings are installed; (iv) Identify if Harnesses Warn and Tied Off When Required when standing elevated above a certain height; (v) Identify if harness is worn when someone is on a scaffold; (vi) Identify if safety Goggles/Sunglasses Worn at All Times; (vii) Identify if Safety Gloves at All Times; (viii) Identify if Proper Footwear; (ix) Identify if Silica Masks are worn; (xii) Identify is someone is wearing a hard hat; (xiii) Alert if machinery or equipment is getting too close to someone that can pose risk; (xiv) Identify if scaffolding is properly installed, secured; (xv) Identify if Control Access Zones are implemented and managed as required; (xvi) Identify overhead work and safety unions.; (xvii) Identify below foot work and safety unions; (xviii) Identify ladder security at top and bottom (properly tied off and braced); (xix) Identify choke hazards i.e. Rigging Cables, hanging cords, objects hanging/dangling; (xx) Identify Trip Hazards i.e. raised screws, extensions cords, unleveled flooring; (xxi) Identify voids in floors, open hatches, bulkhead rises, plumbing cores, elevator shaft edges; (xxii) Identify start of dust hazard; (xxiii) Direct feed to toolbox discussions; (xxiv) Direct feed to site safety meetings; (xxv) Organize behaviors as examples for meeting review; (xxvi) QR Codes Posted to Employee ID to Verify Presence at Site Safety, Tool Box Talk; (xxvii) QR Codes Posted to Employee ID to Verify OSHA Achievement Degree; (xxvii) Identify Hazardous Materials and Forecast Compliance Alarms and Alerts to Key Team Members; (xxviii) Ensure Checklist of Key Forecasted Safety Procedures are reconciled as maintained i.e. debris netting maintain kicks maintained, egress maintained, and fire extinguishers present and compliant; (xxix) Weather Data compiled with compliance alerts issued to key team members in the occurrence of strong conditions; (xxx) Hygiene Stations Maintained; (xxxi) Identify Temp Lighting Compliance; (xxxii) Identify loose or uneven footing; (xxxiii) Identify wet (potentially slippery) surfaces; (xxxiv) Identify snow, rain, ice; (xxxv) Identify if proper signage is posted; (xxxvi) Identify is someone is in a caution or danger area/zone (control access zone); (xxxvii) Identify if proper lock out. Tag out procedures are being met/kept at secure locations and utility areas; (xxxviii) Identify energy control points (electric, gas, water) and ensure that lock out procedures are kept/met; (xxxix) Identify safeguards (or lack thereof) surrounding heavy machinery (i.e. barricades, signs, etc.); (xl) Identify if safety netting is installed and secure when working above a certain height (i.e. 25 feet); (xli) Identify if guardrails are installed at open areas/ledges and if they are to code and properly maintained; and (xlii) Ensure Lifelines, lanyard and safety harnesses are properly secured and that employees are wearing them. The artificial features of the present invention are programmed to recognize after a first occurrence of one or more safety feature alerts to implement corrections in real time for future occurrences.

In an exemplary embodiment, the system disclosed may run an exemplary method of data collection, location, and retrieval to provide one or more functions used to determine one or more of the aforementioned situations or assist in the management of a remote site. With reference to FIG. 6, an exemplary system data location and retrieval method 600 may involve an iterative algorithm that seeks to identify on the relevant storage locations (local storage 35, cloud storage 46, and/or IoT 45) of data necessary to perform a requested function (e.g., identify a hazard). The exemplary method 600 seeks the identification of data by location (local or remote) that already exists on the system (e.g., static and/or a priori information). If the method 600 discovers data is missing, then it engages in a subroutine of dynamic data collection 700, which may be exemplified using FIG. 7.

Referring to FIG. 7, an exemplary dynamic data collection routine 700 involves a primary sub-routine of determining relevancy data from among the stored data on the system. The relevancy data may be based on information obtained from prior dynamic data that has been stored (e.g., prior audio/visual streams), manual inputs to the system (e.g., locality zoning or other rules, statements of work, guidelines, benchmarks, standards, requirements), and artificially constructed relationships based on A.I., machine learning, or other data analytics known to those skilled in the art. Collectively, the system may take the relevancy data and quantitatively ascertain based on prior inputs or manual inputs the permitted degree of deviation from the data to qualify each next data point received on the system as being within the range of the prior relevancy data (i.e., “relevant”) or outside the range of prior relevancy data (i.e., irrelevant). Such data analytic techniques are known to those skilled in the art and are incorporated herein by reference.

With continued reference to FIG. 7, at the completion of collecting all relevancy data, the method then analyzes each audio/video stream on a stream-by-stream basis to determine whether its content is both relevant and has a correlation with pre-acquired data (e.g., static data). Upon determination of all relevant data, the methodology provided by the method of FIG. 7 returns to the system method 600 in which the data necessary to perform a particular function is identified and collected for use.

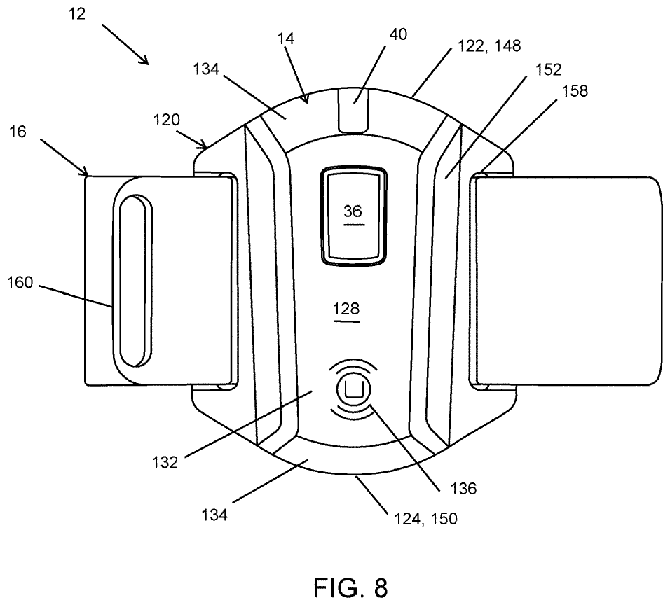

In another exemplary embodiment of the system described herein, an exemplary management system 100 graphical user interface (“GUI”) 50 may provide a list of projects separated by name, location, status, active employee(s), and a selection of stored streams of the named projects as illustratively provided for in FIG. 8A. In the margin of the GUI 50 may be a selection of the project panel from which the wearable recording device of the particular user, in this case a helmet, may be selected. The list of wearable recording devices may be illustratively depicted by way of FIG. 8B. According to the illustrative embodiment of FIG. 8B, an administrator 4 may use the system 100 to determine whether a wearable recording device is on, and identification related to the same. Referring to the illustrative embodiment of FIG. 8C, the system GUI may provide the geographic location of a particular managed activity based on GPS or other location inputs from one or more wearable technologies at the particular location. As may be illustrated by FIG. 8C, it is also contemplated that based on the inputs from the wearable data recorders, the system may use that data to enable the administrator 4 to determine weather, geographic location, directions to the location, and project activity, among other things.

According to another exemplary embodiment, a live stream 5A may be shown in GUI 50 for a particular wearable device user. As shown to the right of the live stream 5A, the administrator 4 may be able to view the duration of the user's live stream and also see what is being seen by the user of the wearable device via the GUI. As previously disclosed, the transmission of the live stream from the activity location to the dashboard/GUI 50 of the admin 4 may be in real time similar to that of Zoom, Microsoft® Teams, Google Meet, or other collaborative online transmission platform known to those skilled in the art. As previously disclosed, the transmission of live stream 5A may be stored via the system architecture for later reference by administrator 4. In an exemplary embodiment, the dashboard/GUI 50 may allow the administrator 4 to view the history of streams recorded at a particular location by one or more users of a wearable recording device, as may be shown by the selectable rectangular user tabs to the right of the stream 5A depicted in FIG. 8E.

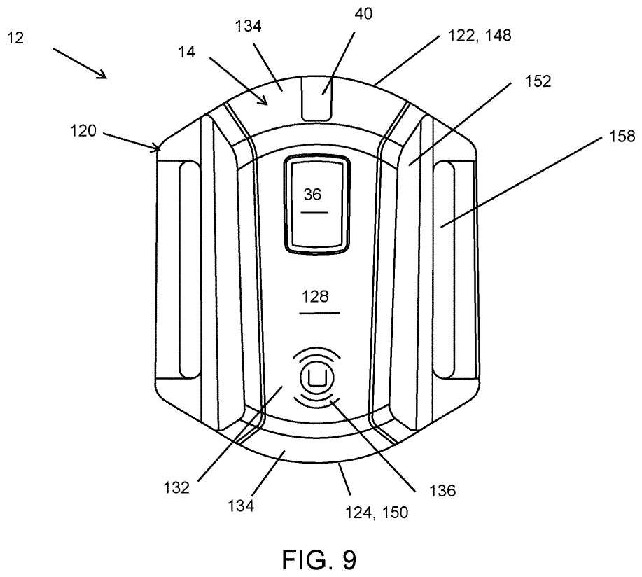

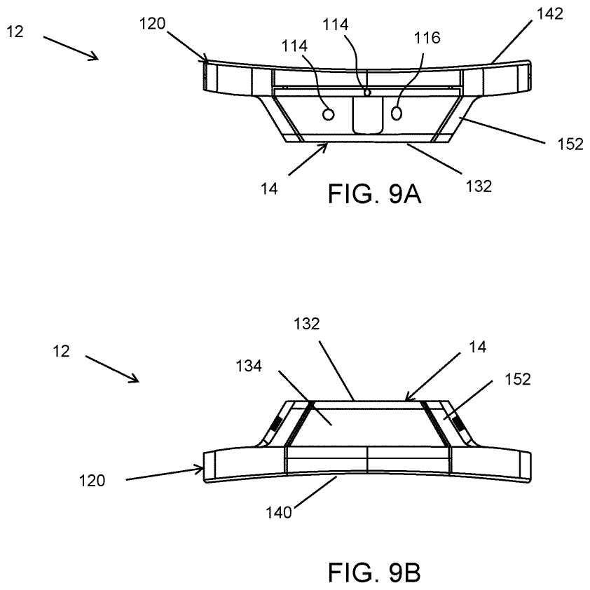

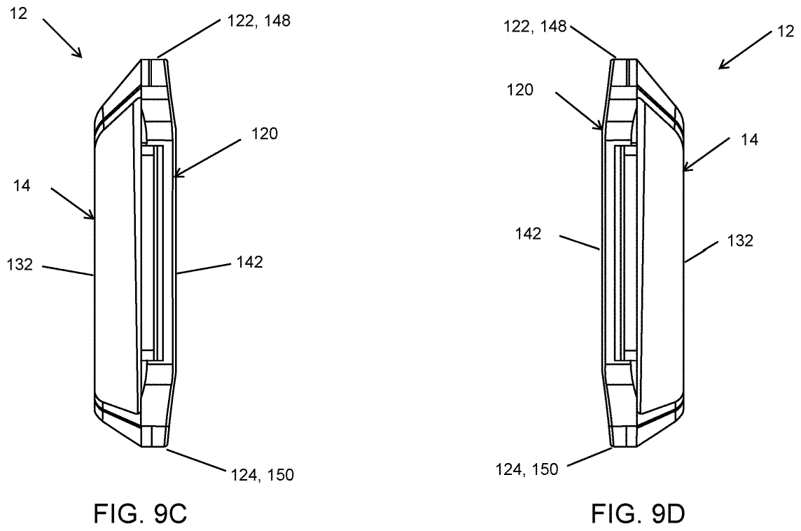

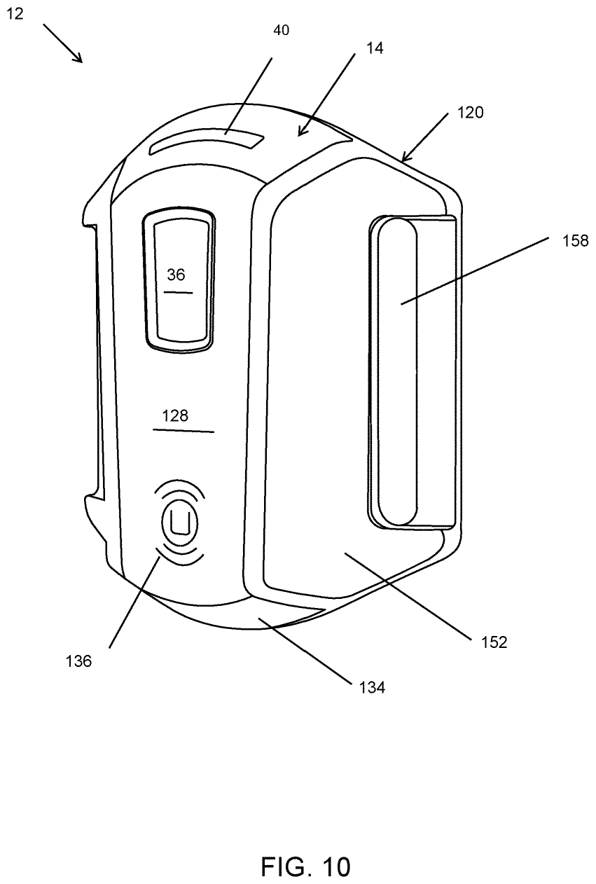

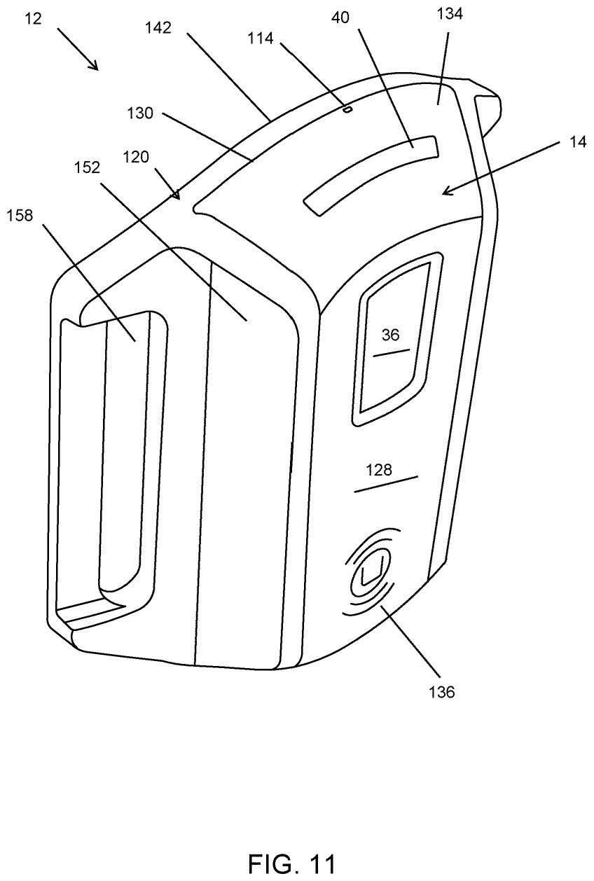

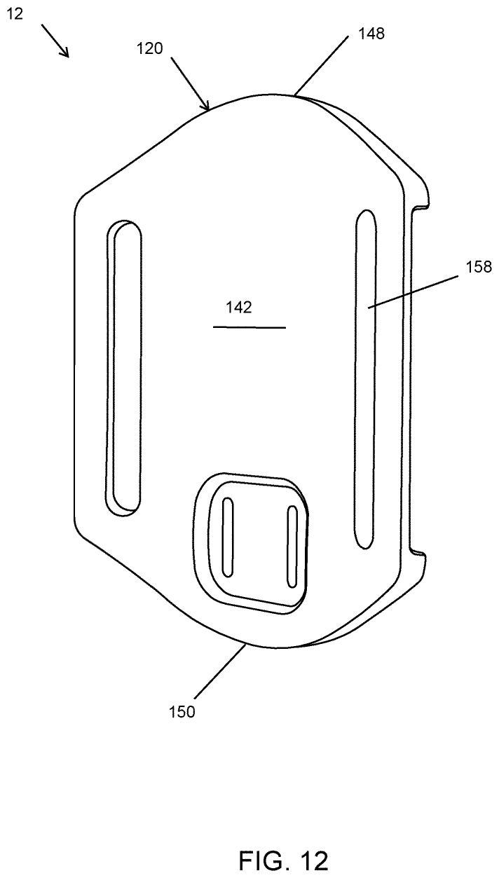

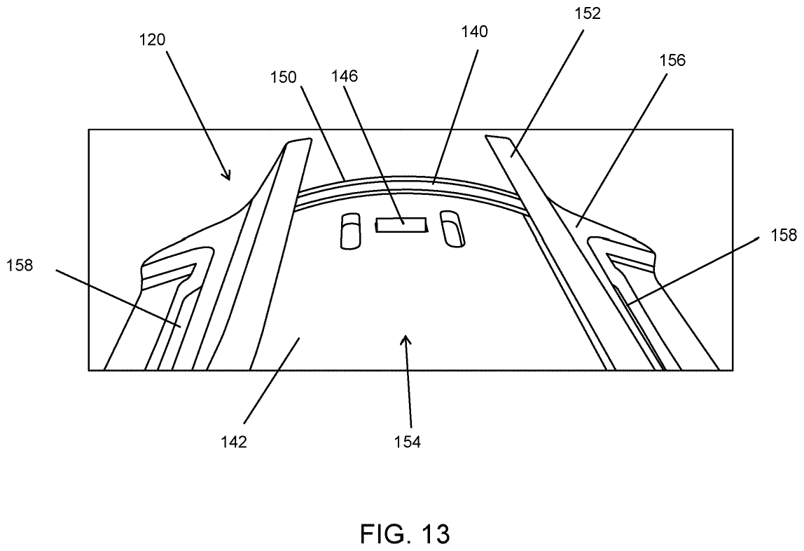

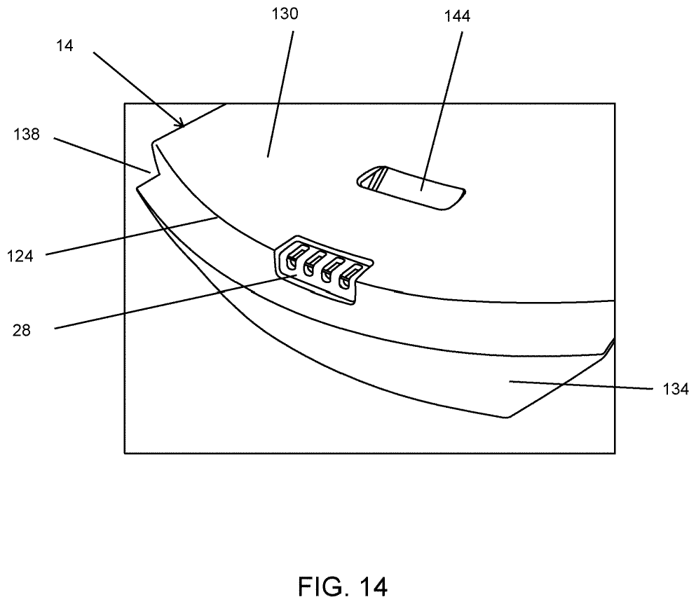

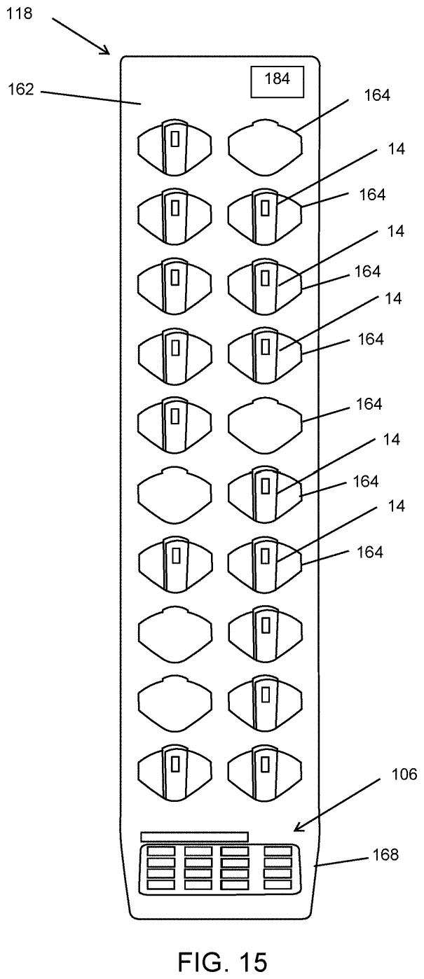

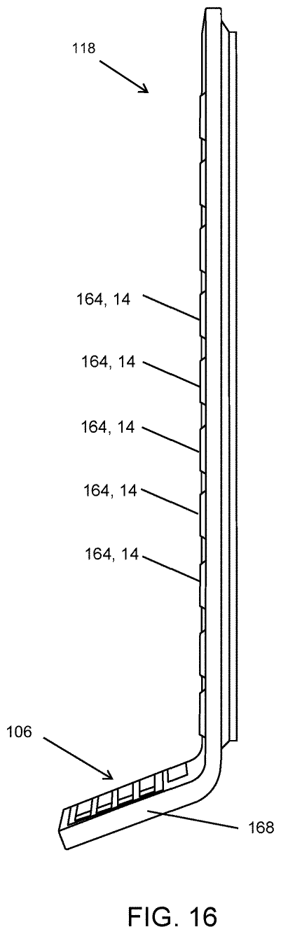

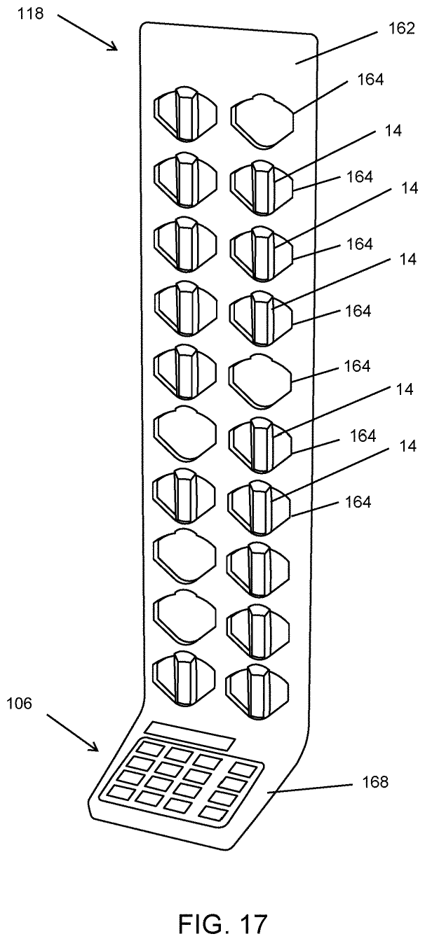

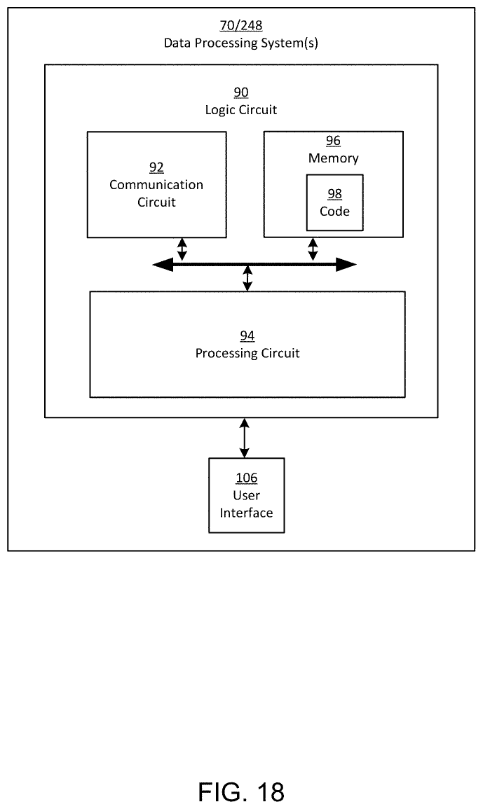

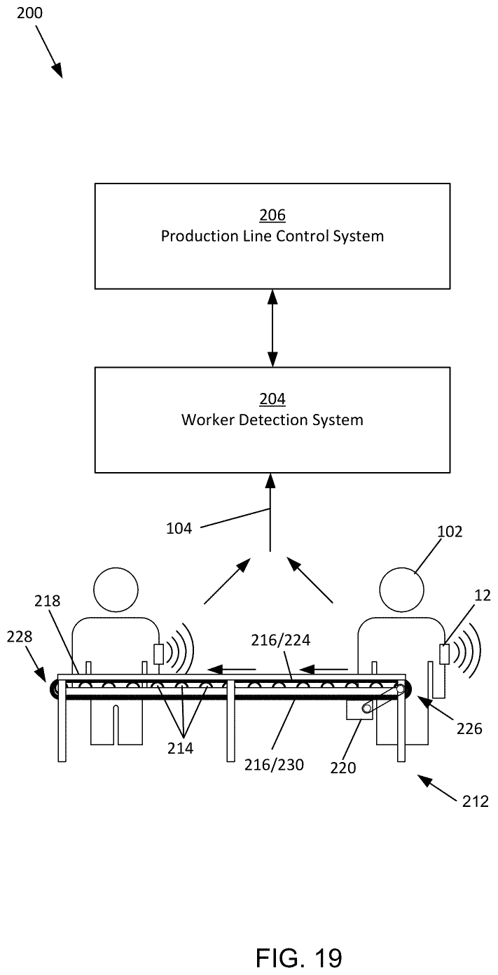

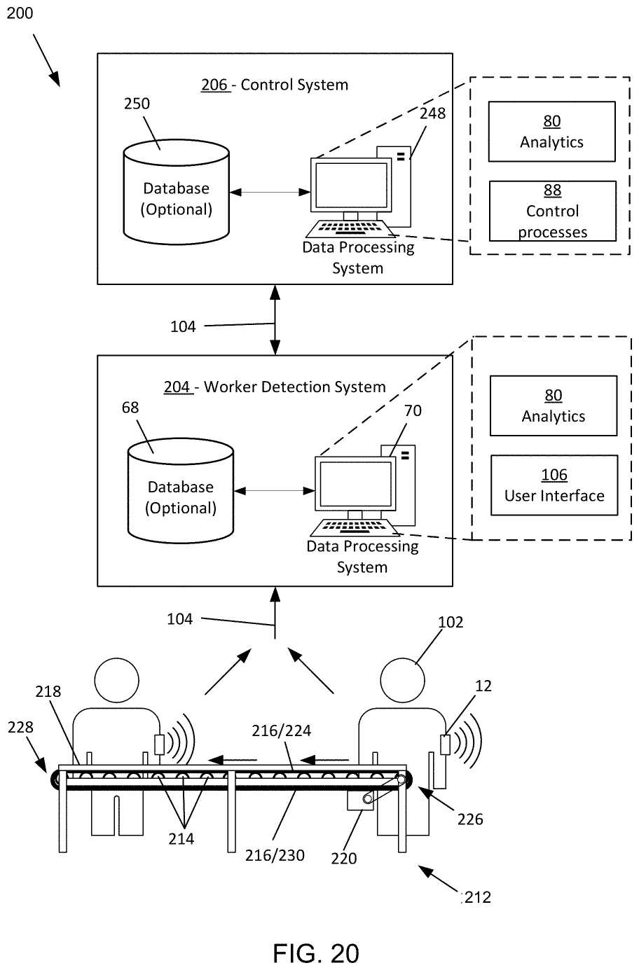

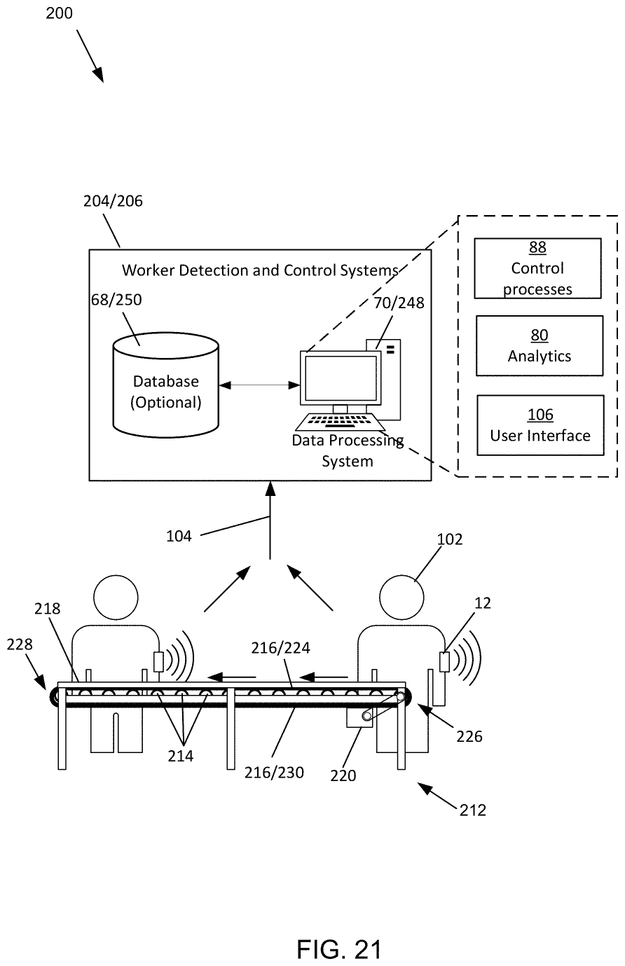

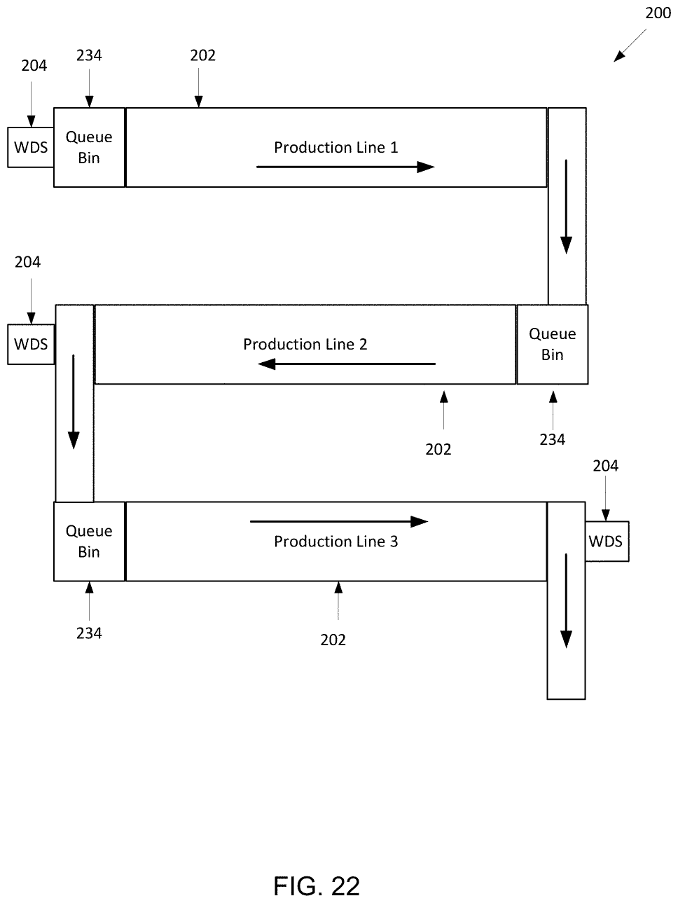

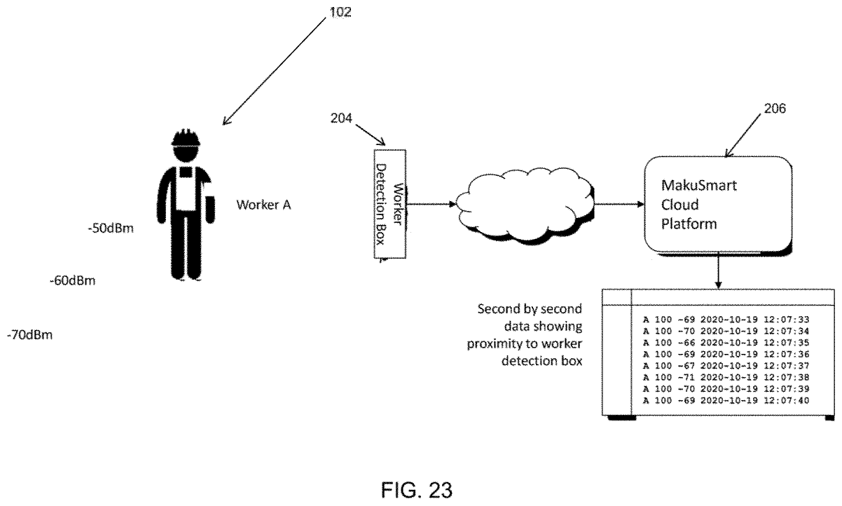

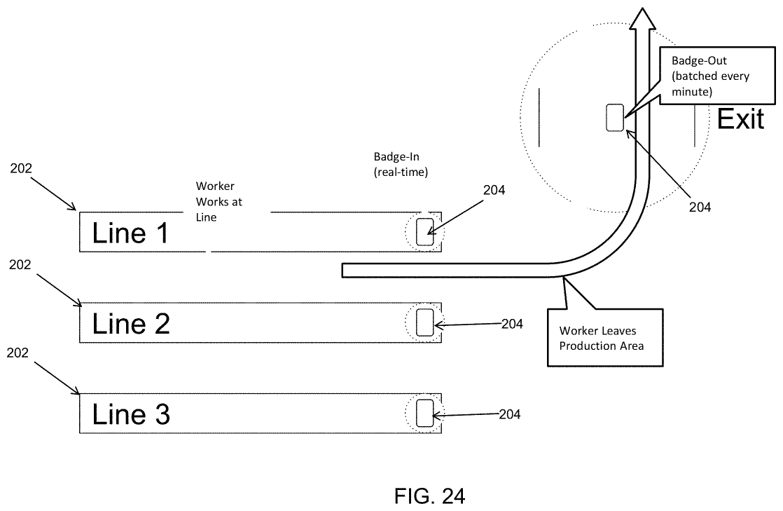

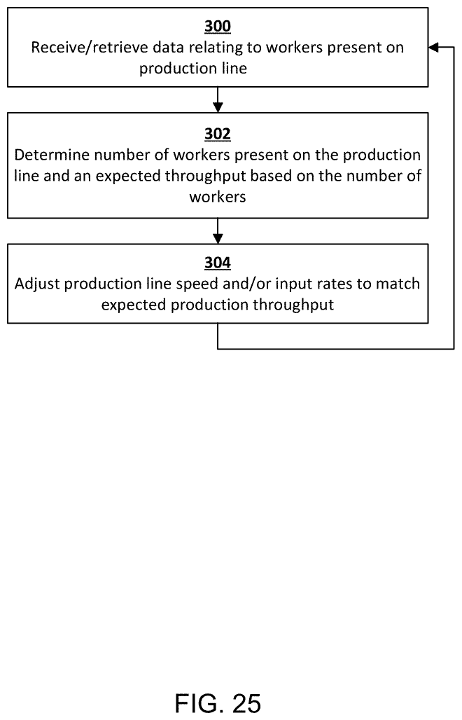

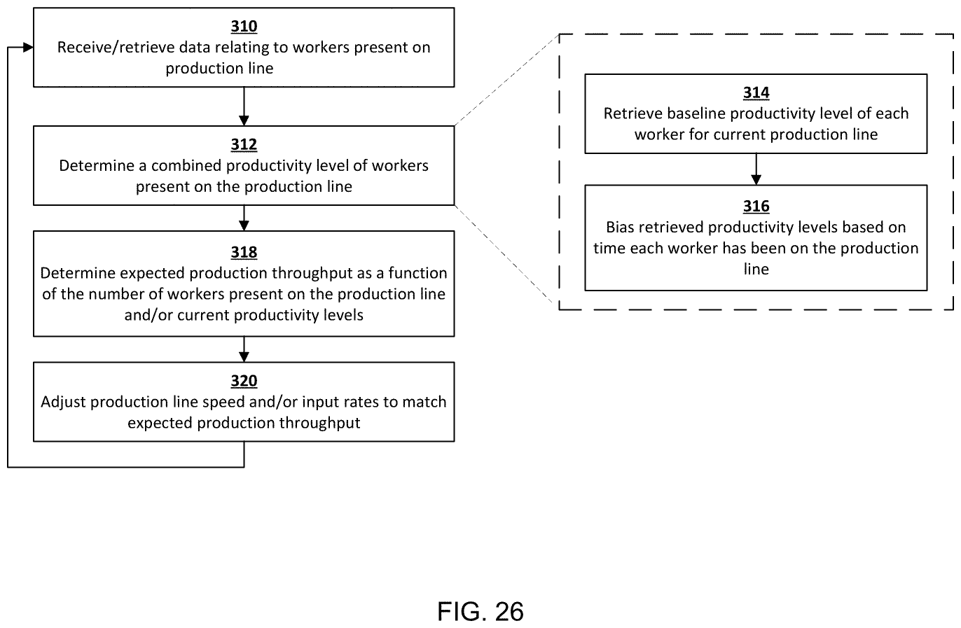

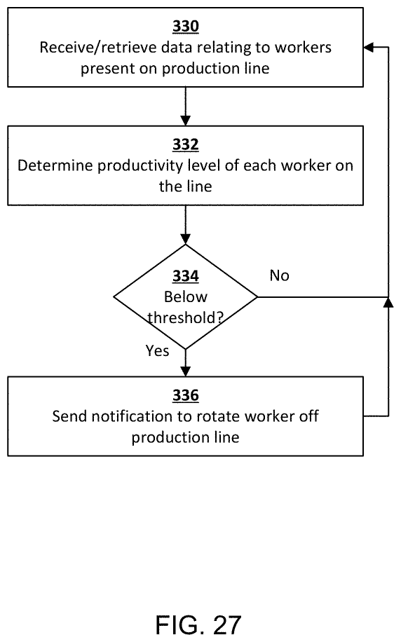

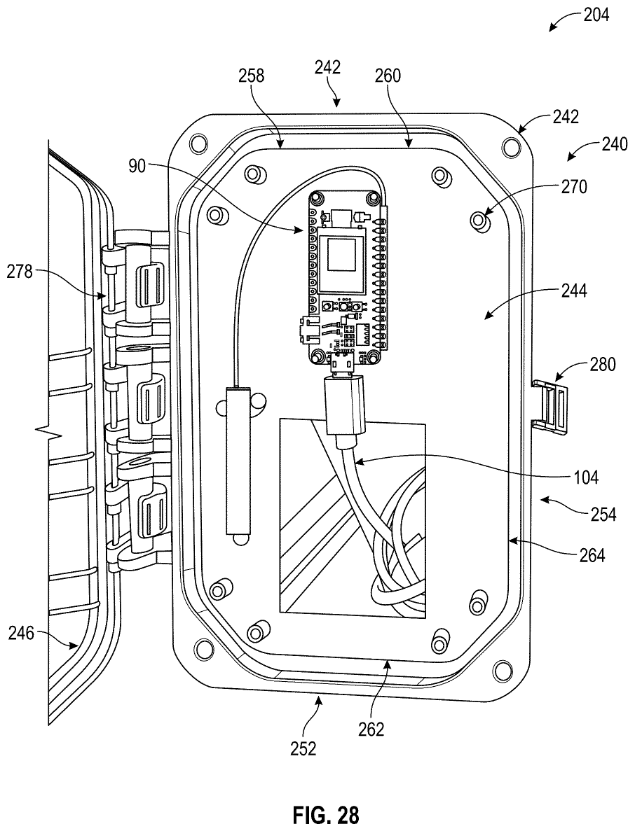

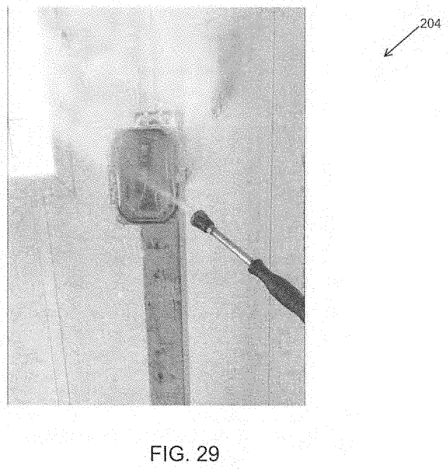

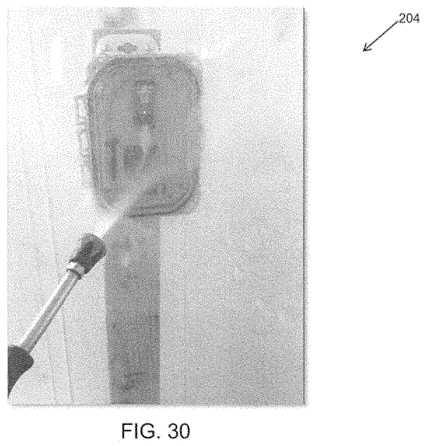

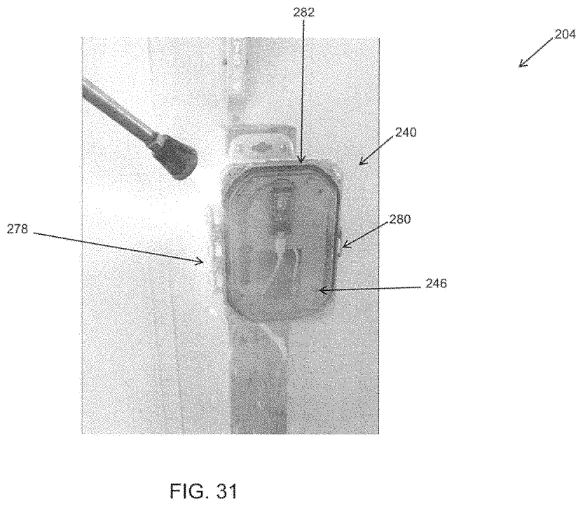

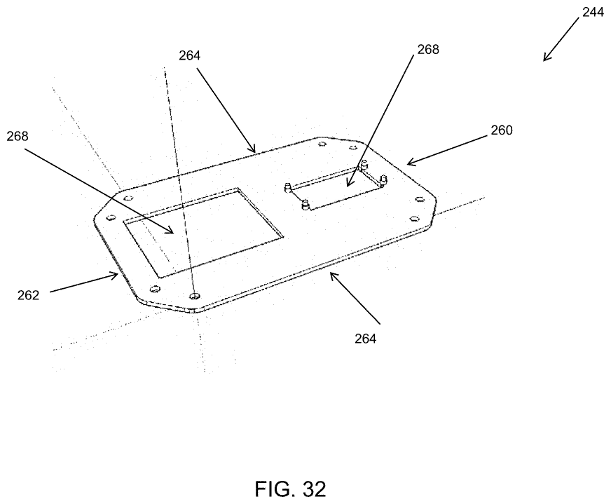

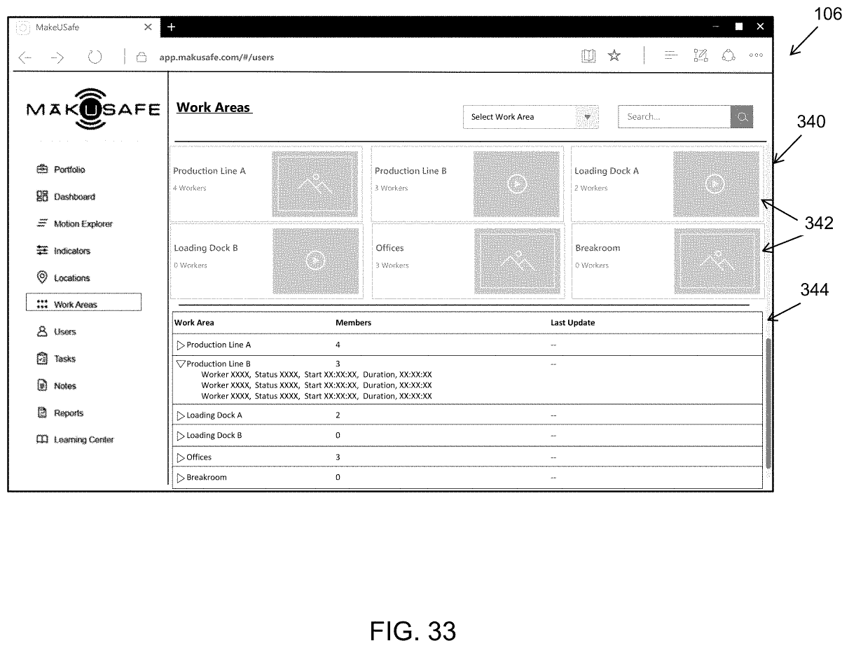

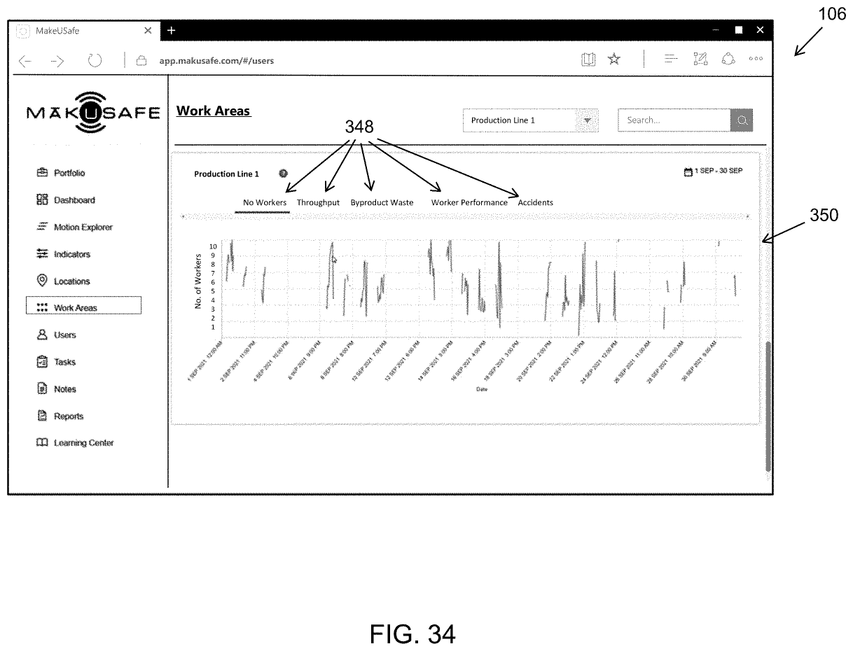

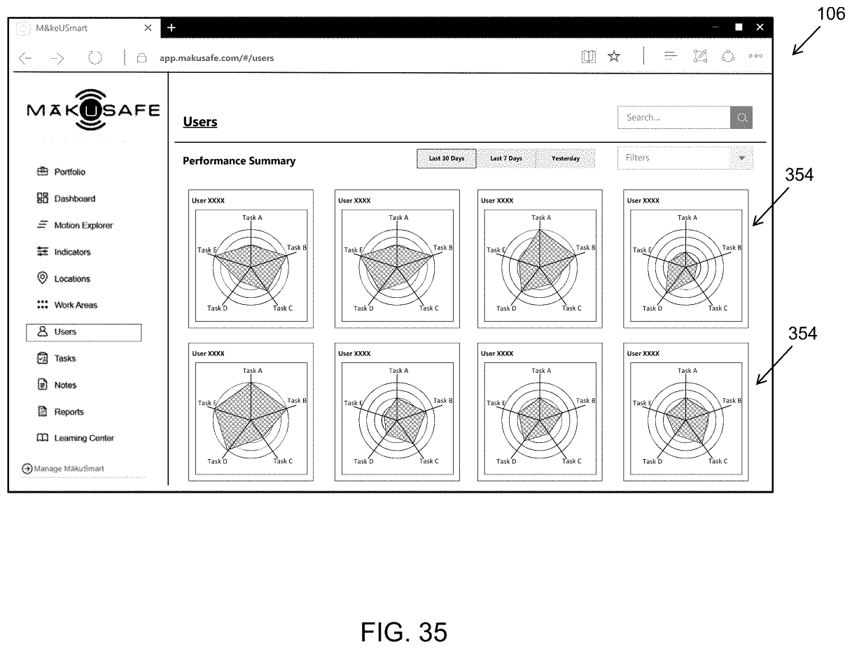

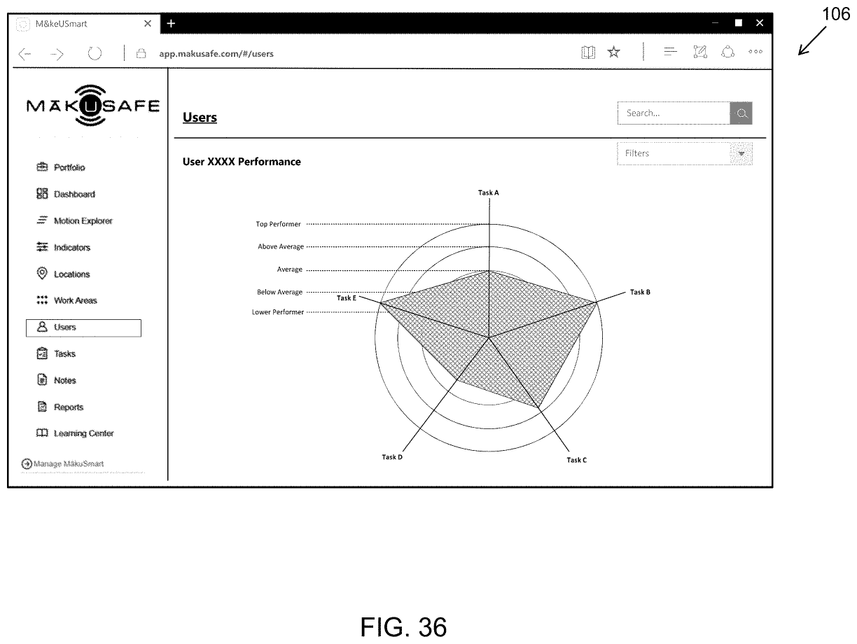

In a preferred embodiment and as illustratively provided for in FIG. 9, an exemplary system 100 may comprise a plurality of tenants within which a dashboard/GUI 50 may be operated via a configured video conference platform through which streams of audio/visual data may be recorded and stored. As depicted, an exemplary system 100, which may be also characterized as a virtual manager system 100, may utilize audio and/or video data from users (e.g., workers) with wearable recording devices (e.g., helmets), and through such data provide virtual manager access to one or more tenants. In an exemplary embodiment, each tenant would then be capable of supplying the ultimate virtual manager panel with a selection (in this case 4 different selections for each of the 4 tenants) of activity data from users at a particular location. Thus, the virtual manager system 100 as illustrated in FIG. 9, may provide a multitude of control to a single administrator that has heretofore not been made possible with the state of the art.

Many further variations and modifications may suggest themselves to those skilled in art upon referring to above disclosure and foregoing illustrative and interrelated and interchangeable embodiments, which are given by way of example only, and are not intended to limit the scope and spirit of the interrelated embodiments of the invention described herein. It should be understood, however, that it is not intended to limit the invention to the particular form disclosed, but rather, the invention is to cover all modifications, equivalents, and alternatives falling with the scope and spirit of the invention.

1. A management system for managing activity at a first location, comprising:
a dashboard configured to receive one or more inputs recorded at the first location, wherein the one or more inputs include audio data, visual data, and combinations of the same; and
a wireless transmission connection between at least one remote recording device located at the first location and the dashboard, wherein the first location and the dashboard are remote from one another, wherein
the dashboard renders the one or more inputs in real time and in a format in which they are communicated via the wireless transmission connection, and
at least a portion of the one or more inputs may be selected via the dashboard to create an output in the management system, wherein the management system enables the output to be sent to at least one remote recording device via the wireless transmission connection.

2. The management system of claim 1, wherein the at least one remote recording device is a wearable recording device.

3. The management system of claim 1, further comprising a storage for the one or more inputs.

4. The management system of claim 1, wherein the dashboard can render a plurality of inputs in real time simultaneously.

5. The management system of claim 2, wherein the dashboard can render a plurality of inputs in real time simultaneously.

6. The management system of claim 3, wherein the storage is also for the output.

7. The management system of claim 1, wherein the dashboard renders the one or more inputs in real time in conjunction with at least one non-recorded input.

8. The management system of claim 1, wherein the management system uses one of artificial intelligence or a pre-defined program to enable the output to be sent to the at least one remote recording device via the wireless transmission connection.

9. The management system of claim 1, wherein the dashboard is configured to receive one or more inputs recorded over a plurality of locations other than the first location.

10. The management system of claim 9, wherein the dashboard can render a plurality of inputs from a plurality of locations in real time simultaneously.

11. The management system of claim 10, wherein the plurality of inputs come from a plurality of wearable recording devices.

12. The management system of claim 11, wherein the dashboard renders the plurality of inputs in real time in conjunction with at least one non-recorded input.

13. The management system of claim 1, further comprising at least one storage for the one or more inputs recorded over the plurality of locations and the first location.

14. The management system of claim 12, wherein the management system uses one of artificial intelligence or a pre-defined program to enable the output to be sent to one of the plurality of wearable recording devices via the wireless transmission connection.

15. The management system of claim 14, wherein the management system uses one of artificial intelligence or a pre-defined program to enable the output to be sent to a plurality of wearable recording devices via the wireless transmission connection.

16. The management system of claim 14, wherein the dashboard is configured to instruct the management system on which of the plurality of wearable devices to send the output via the wireless transmission connection.

17. The management system of claim 14, wherein the dashboard is configured to instruct the management system in what format to send the output via the wireless transmission connection.

18. The management system of claim 17, wherein the dashboard is configured to instruct the management system in what format to send the output via the wireless transmission connection to each of the plurality of wearable devices.

19. A management system for managing activities at a remote location, comprising:
a controller by which the management system receives remote inputs and delivers outputs to the remote location;
a wearable recording device configured to transmit and receive data to the controller via a wireless transmission, wherein the data includes, audio data, visual data, text data, and combinations of the same;
a storage unit digitally coupled to the controller and the wearable recording device, wherein at least
a wireless transmission connection between at least one remote recording device located at the first location and the dashboard, wherein the first location and the dashboard are remote from one another, wherein
the dashboard renders the one or more inputs in real time and in a format in which they are communicated via the wireless transmission connection, and
at least a portion of the one or more inputs may be selected via the dashboard to create an output in the management system, wherein the management system enables the output to be sent to at least one remote recording device via the wireless transmission connection.

20. The management system of claim 19, wherein the dashboard renders the one or more inputs from a plurality of remote recording devices simultaneously.
